(19) United States
(12) Patent Application Publication
(10) Pub. No.: US 2015/0264625 A1
(43) Pub. Date: Sep. 17, 2015

(54) WIRELESS RECEIVER APPARATUS AND WIRELESS COMMUNICATION METHOD

(71) Applicant: Kiwamu WATANABE, Kanagawa (JP)

(72) Inventor: Kiwamu WATANABE, Kanagawa (JP)

(73) Assignee: RICOH COMPANY, LTD., Tokyo (JP)

(21) Appl. No.: 14/631,977

(22) Filed: Feb. 26, 2015

(30) Foreign Application Priority Data
Mar. 14, 2014 (JP) 2014-052059

(51) Int. Cl. H04W 40/12; H04W 24/08

(52) U.S. Cl. CPC H04W 40/12; H04W 24/08

(57) ABSTRACT

A wireless receiver apparatus, executing a wireless communication with wireless transmitting apparatuses, includes a radio wave strength detection unit to detect a reception radio wave strength from a first wireless transmitting apparatus executing the wireless communication; a data source switching pattern storage unit to store a switching pattern to switch a data source to a second wireless transmitting apparatus based on the reception radio wave strength from the first wireless transmitting apparatus; a communication control unit to switch the data source to the second wireless transmitting apparatus, based on the switching pattern stored in the data source switching pattern storage unit, and a detection result from the radio wave strength detection unit; and a wireless communication unit to execute the wireless communication with the first wireless communication apparatus or the second wireless transmitting apparatus, depending on control by the communication control unit.

### BACKGROUND OF THE INVENTION

1. Field of the Invention

The disclosures herein generally relate to a communication system.

2. Description of the Related Art

In recent years, a wireless network projector system has been developed that uses a wireless network (the wireless LAN or millimeter wave communication) without using cables and the like, wirelessly transmits a video interface signal of an imaging device such as a PC (Personal Computer) to be output on a screen, to a display unit such as a projector or a monitor, and projects images on the display unit.

When wirelessly transmitting video data and audio data among multiple wireless communication apparatuses, a technology has been known that makes it possible to reproduce video data and audio data at one touch of a user by using wireless technology (see, for example, Patent Document 1).

Another technology has been known that uses an AV system, which is constituted with a display unit, multiple imaging devices connected with the display unit, and a remote controller to control the imaging devices, and selects and changes the imaging devices to be displayed on the display unit by pushing down a button on the remote control (see, for example, Patent Document 2).

### RELATED-ART DOCUMENTS

### Patent Documents

[Patent Document 1] Japanese Laid-open Patent Publication NO. 2008-252929
[Patent Document 2] Japanese Laid-open Patent Publication NO. 2004-208290

Consider a situation where a user selects one of multiple imaging devices and modules attached to the imaging devices, and has the imaging devices and modules transmit video data and audio data to the one of the display units or modules. The one of the display units and the modules attached to the display unit projects the video data and audio data.

In this case, the user cannot select the imaging devices or the modules that transmits the video data and audio data.

Also, when attaching a module to a video output interface, the size of an attachment part needs to be as small as possible. Therefore, multiple user input units or a complex user input unit cannot be attached to such a video output interface.

Thereupon, it is a general object of at least one embodiment of the present invention to provide an image processing apparatus that substantially obviates one or more problems caused by the limitations and disadvantages of the related art. Specifically, it may be desirable to easily switch among imaging devices from which data is to be transmitted a display unit.

### SUMMARY OF THE INVENTION

According to at least one embodiment of the present invention, a wireless receiver apparatus, executing a wireless communication with a plurality of wireless transmitting apparatuses, includes a radio wave strength detection unit configured to detect a reception radio wave strength from a first wireless transmitting apparatus executing the wireless communication; a data source switching pattern storage unit configured to store a switching pattern to switch a data source of the wireless communication to a second wireless transmitting apparatus based on the reception radio wave strength from the first wireless transmitting apparatus; a communication control unit configured to switch the data source of the wireless communication to the second wireless transmitting apparatus, based on the switching pattern stored in the data source switching pattern storage unit, and a detection result from the radio wave strength detection unit; and a wireless communication unit configured to execute the wireless communication with the first wireless communication apparatus or the second wireless transmitting apparatus, depending on control by the communication control unit.

According to at least one embodiment of the present invention, it is possible to easily switch among imaging devices from which data is to be transmitted to a display unit.

### BRIEF DESCRIPTION OF DRAWINGS

FIG. 1 is a diagram illustrating a communication system according to an embodiment;

FIG. 2 is a diagram illustrating a transmission frame according to an embodiment;

FIG. 3 is a diagram illustrating reception power of an electromagnetic wave at a sink apparatus;

FIG. 4 is a diagram illustrating an example of a relationship between time and reception power of an electromagnetic wave at a sink apparatus;

FIG. 5 is a diagram illustrating an example of correspondences between operational patterns on a source apparatus, and reception strengths of an electromagnetic wave, which has been transmitted from the source apparatus, when received at a sink apparatus;

FIG. 6 is a diagram illustrating an example of an operation determination table;

FIG. 7 is a diagram illustrating a reception/transmission process in a wireless network projector system according to a first embodiment;

FIG. 8 is a diagram illustrating a reception/transmission process in a wireless network projector system according to a second embodiment;

FIG. 9 is a sequence chart illustrating operations of a wireless network projector system according to an embodiment;

FIG. 10 is a diagram illustrating a transmitted message according to an embodiment;

FIG. 11 is a diagram illustrating a transmitted message according to an embodiment;

FIG. 12 is a flowchart illustrating operations of a wireless communication system according to an embodiment;

FIG. 13 is a flowchart illustrating operations of a wireless communication system according to an embodiment;

FIG. 14 is a diagram illustrating a reception/transmission process in a wireless network projector system according to a third embodiment;

FIG. 15 is a sequence chart illustrating operations of a wireless network projector system according to a modified example;

FIG. 16 is a diagram illustrating a communication system according to an embodiment;

FIG. 17 is a diagram illustrating a communication system according to an embodiment;

FIG. 18 is a flowchart illustrating operations of a wireless network projector system according to an embodiment;

FIG. 19 is a diagram illustrating a communication system according to an embodiment; and

FIG. 20 is a sequence chart illustrating operations of a wireless network projector system according to an embodiment.

### DESCRIPTION OF THE PREFERRED EMBODIMENTS

Next, embodiments of the present invention will be described with reference to the drawings. The following embodiments are just examples, and the present invention is not limited to the following embodiments. Note that the same numerical codes are used for elements having the same functions throughout the drawings, and their description may not be repeated.

### First Embodiment

### Communication System

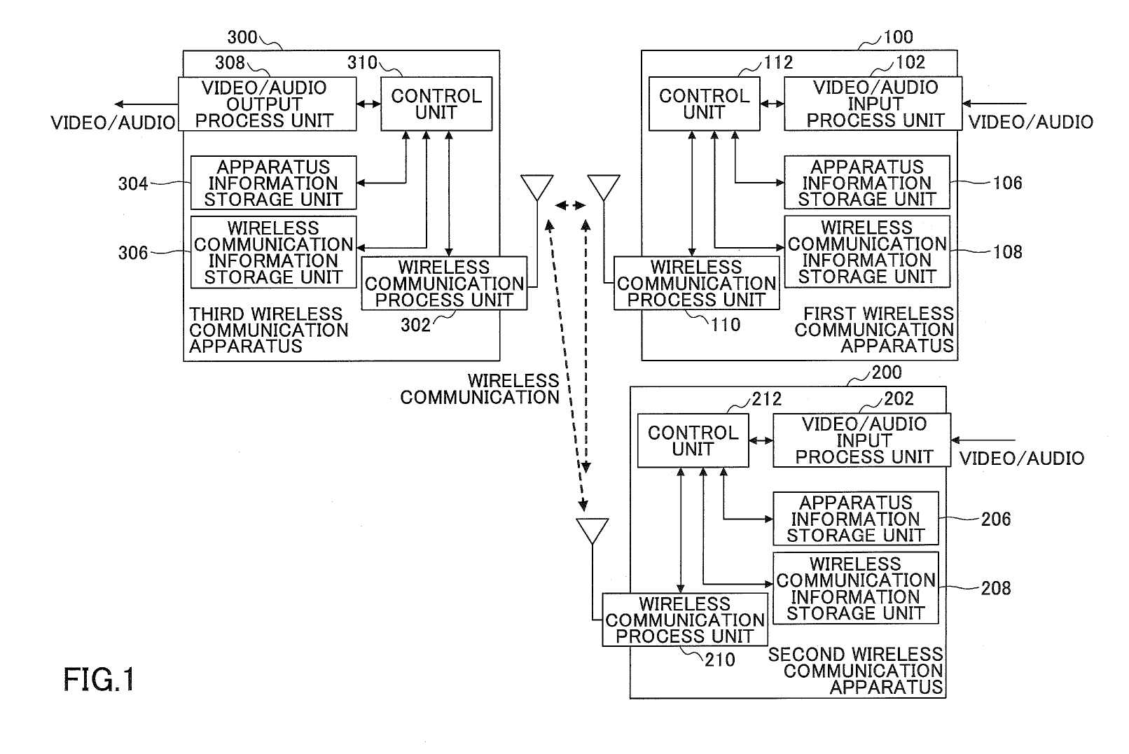

FIG. 1 illustrates an embodiment of a communication system. In FIG. 1, a wireless network projector system is illustrated as an embodiment of a communication system.

The wireless network projector system is constituted with a first wireless communication apparatus 100, a second wireless communication apparatus 200, and a third wireless communication apparatus 300.

The first wireless communication apparatus 100 and the second wireless communication apparatus 200 are connected with video/audio output terminals that output video data and audio data, respectively. In the following, the first wireless communication apparatus 100 and the second wireless communication apparatus 200 function as wireless transmitting apparatuses, and may be referred to as the first source apparatus and the second source apparatus, respectively. It is preferable that the video/audio output terminals are those included in terminal devices such as PCs (Personal Computers) or mobile terminal devices such as media players. The wireless network projector system may include three or more wireless communication apparatuses that have the same function as the first wireless communication apparatus 100 and the second wireless communication apparatus 200.

The third wireless communication device 300 inputs video data and audio data from the first wireless communication apparatus 100 and the second wireless communication apparatus 200, into a video/audio input terminal of a display unit of a TV or a projector. In the following, video data and audio data are together referred to as video/audio data. In the following, the third wireless communication apparatus 300 functions as a wireless receiver apparatus, and may be referred to as the sink apparatus.

<First Wireless Communication Apparatus 100>

The first wireless communication apparatus 100 includes a video/audio input process unit 102, an apparatus information storage unit 106, a wireless communication information storage unit 108, a wireless communication process unit 110, and a control unit 112. The second wireless communication apparatus 200 may have the same configuration as the first wireless communication apparatus 100.

The video/audio input process unit 102 receives video/audio data as input from the video/audio output terminal with which the first wireless communication apparatus 100 is connected. It is preferable that the video/audio output terminal is compliant with standards such as DVI (Digital Visual Interface) and HDMI (trademark, High-Definition Multimedia Interface). The video/audio input process unit 102 inputs the video/audio data into the control unit 112. The wireless communication process unit 110 receives as input the video/audio data that has been input into the control unit 112.

The apparatus information storage unit 106 stores an ID specific to the wireless communication apparatus. Note that the specific ID of a wireless communication apparatus is the MAC address of the first source apparatus, the second source apparatus, or the sink apparatus. The specific ID of a wireless communication apparatus is not limited to a MAC address, but may be another identifier (identification information).

The wireless communication information storage unit 108 stores a frequency band used for a wireless communication, reservation information of a band for transmitting video/audio data, and a stream ID.

The control unit 112 is connected with the video/audio input process unit 102, the apparatus information storage unit 106, and the wireless communication information storage unit 108. The control unit 112 controls the video/audio input process unit 102, the apparatus information storage unit 106, the wireless communication information storage unit 108, and the wireless communication process unit 110. The control unit 112 is constituted with a CPU (Central Processing Unit), a memory, and the like.

Control data (a message) transmitted from the third wireless communication apparatus 300 is received by the wireless communication process unit 110, and is input into the control unit 112.

The control unit 112 determines whether the control data input from the wireless communication process unit 110, is a request for starting transmission of video/audio data input from the video/audio input process unit 102 (referred to as a “transmission start request”), or a request for stopping the transmission of the video/audio data (referred to as a “transmission stop request”).

The control unit 112 controls transmitting to the third wireless communication apparatus 300 a response to the control data (transmission start request) input from the wireless communication process unit 110. If the control data is a transmission start request, the second wireless communication apparatus 200 and the third wireless communication apparatus 300 exchange the control data, and the second wireless communication apparatus 200 stops transmitting the video/audio data. Specifically, the third wireless communication apparatus 300 transmits to the second wireless communication apparatus 200, a transmission stop request to stop transmitting the video/audio data. In response to the transmission stop request from the third wireless communication apparatus 300, the control unit 212 of the second wireless communication apparatus 200 controls stopping the transmission of video/audio data.

The control unit 112 controls the wireless communication process unit 110 to transmit the video/audio data from the video/audio input process unit 102, to the third wireless communication apparatus 300.

The control unit 112 controls transmitting the response to the control data (transmission stop request) input from the wireless communication process unit 110, to the third wireless communication apparatus 300, and stops controlling the wireless communication process unit 110 to transmit the video/audio data from the video/audio input process unit 102, to the third wireless communication apparatus 300. If the control data is a transmission stop request, the second wireless communication apparatus 200 and the third wireless communication apparatus 300 exchange the control data, and the second wireless communication apparatus 200 transmits the video/audio data. Specifically, the third wireless communication apparatus 300 transmits to the second wireless communication apparatus 200, a transmission start request to start transmitting the video/audio data. In response to the transmission start request from the third wireless communication apparatus 300, the control unit 212 of the second wireless communication apparatus 200 controls starting the transmission of video/audio data.

The control unit 112 includes functions that are described as the functions of the control unit 212.

The wireless communication process unit 110 is connected with the control unit 112. The wireless communication process unit 110 wirelessly transmits video/audio data. It is preferable that the wireless communication process unit 110 executes wireless transmission following standards such as WiMedia (IEEE [The Institute of Electrical and Electronics Engineers, Inc.] 802.15.3a, ECMA-368), IEEE 802.11 wireless LAN, millimeter-wave based wireless PAN (IEEE 802.15.3c).

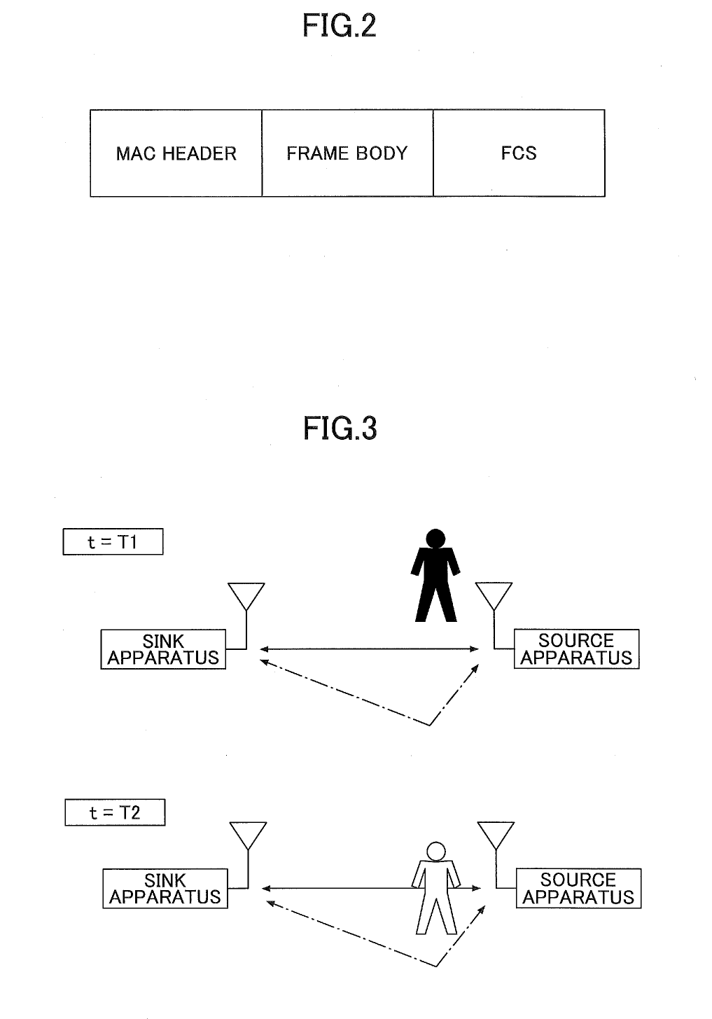

FIG. 2 illustrates an embodiment of a frame transmitted by the wireless communication process unit 110. In FIG. 2, a basic format is illustrated for a MAC (Medium Access Control) frame of IEEE802.11 wireless LAN.

The basic format of a MAC frame of IEEE802.11 wireless LAN is constituted with a MAC header, a frame body, and a FCS (Frame Check Sequence).

Frame control information and a MAC address of a transmission source are incidental to the MAC header.

Transmission data is incidental to the frame body.

An error correction code of the MAC header and frame body is incidental to the FCS.

In the present embodiment of the wireless network projector system, the MAC address of the wireless communication apparatus wirelessly transmitting the video/audio data is incidental to the MAC header, the video data and the voice data are incidental to the frame body.

When using wireless communication standards other than IEEE802.11 wireless LAN, such as WiMedia or millimeter-wave based wireless PAN (IEEE802.15.3c), the basic format of a frame does not have much difference.

<Third Wireless Communication Apparatus 300>

The third wireless communication apparatus 300 includes a wireless communication process unit 302, an apparatus information storage unit 304, a wireless communication information storage unit 306, a video/audio output processing unit 308, and a control unit 310.

The wireless communication process unit 302 as a wireless communication unit receives synchronization data, control data, and video/audio data from the first wireless communication apparatus 100 and the second wireless communication apparatus 200. It is preferable that the wireless communication process unit 302 receives the data following standards such as WiMedia (IEEE [The Institute of Electrical and Electronics Engineers, Inc.] 802.15.3a, ECMA-368), IEEE 802.11 wireless LAN, millimeter-wave based wireless PAN (IEEE 802.15.3c). The wireless communication process unit 302 inputs the received synchronization data, control data, and video/audio data into the control unit 310. Further, the wireless communication process unit 302 functions as a radio wave strength detection unit that detects strengths of reception power of electromagnetic waves transmitted from the first wireless communication apparatus 100 and the second wireless communication apparatus 200, and inputs the strengths into the control unit 310.

The apparatus information storage unit 304 stores an ID specific to the wireless communication apparatus. Here, the specific ID of a wireless communication apparatus is preferably the MAC address of the first source apparatus, the second source apparatus, or the sink apparatus. The specific ID of a wireless communication apparatus is not limited to a MAC address, but may be another identifier (identification information).

The wireless communication information storage unit 306 stores a frequency band used for a wireless communication, reservation information of a band for transmitting video/audio data, and a stream ID.

Further, the wireless communication information storage unit 306 stores an operation determination table in which the third wireless communication apparatus 300 has reception power of electromagnetic waves transmitted from the first wireless communication apparatus 100 and the second wireless communication apparatus 200, associated with operations performed for the first wireless communication apparatus 100 and the second wireless communication apparatus 200, respectively.

FIG. 3 is a diagram illustrating reception power of an electromagnetic wave as reception radio wave strength at the sink apparatus. In FIG. 3, the source apparatuses corresponds to the first wireless communication apparatus 100 or the second wireless communication apparatus 200, and the sink apparatus corresponds to the third wireless communication apparatus 300.

At time T1 (t=T1), on a line connecting the source apparatus and the sink apparatus, there are no electromagnetic wave absorbing materials, for example, a human body that tends to absorb a radio wave. In this case, the reception power at the sink apparatus is I1 for the electromagnetic wave transmitted from the source apparatus.

At time T2 (t=T2), on the line connecting the source apparatus and the sink apparatus, there is an electromagnetic wave absorbing material. In this case, the reception power at the sink apparatus is I2 for the electromagnetic wave transmitted from the source apparatus.

If the first wireless communication apparatus 100 and the second wireless communication apparatus 200 transmit millimeter waves, the millimeter waves need to be transmitted from the source apparatuses with a directivity higher than that of the wireless LAN because a millimeter wave is an electromagnetic wave that has a higher frequency than an electromagnetic wave used for the wireless LAN. It is assumed that a diffracted wave of an electromagnetic wave transmitted with a higher directivity exhibits a small reception strength even if the diffracted wave reaches the sink apparatus. Also, if not using a millimeter wave communication that uses an electromagnetic wave having a high directivity and a high frequency, the reception power of an electromagnetic wave at the sink apparatus gets smaller when the position of an electromagnetic wave absorbing material is closer to the antenna of the source apparatus.

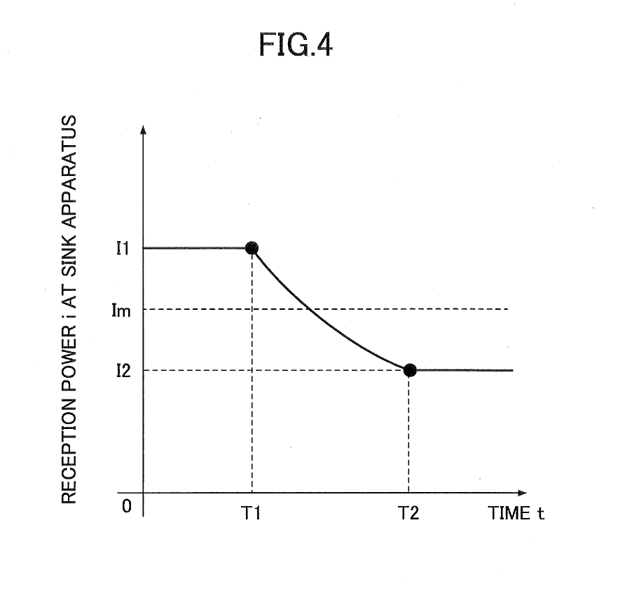

FIG. 4 illustrates an example of a relationship between time and reception power of an electromagnetic wave at the sink apparatus. A case will be described where an electromagnetic wave absorbing material approaches the line between the source apparatus and the sink apparatus while time passes. In FIG. 4, the horizontal axis represents time, and the vertical axis represents the reception power i at the sink apparatus. As illustrated in FIG. 3, at time T1 (t=T1), there are no electromagnetic wave absorbing materials on the line connecting the source apparatus and the sink apparatus, and the reception power at the sink apparatus is I1 for the electromagnetic wave transmitted from the source apparatus. At time T2 (t=T2), there is an electromagnetic wave absorbing material on the line connecting the source apparatus and the sink apparatus, and the reception power at the sink apparatus is I2 for the electromagnetic wave transmitted from the source apparatus where I1 is greater than I2. Note that between time T1 and T2, the electromagnetic wave absorbing material gradually comes closer to the line connecting the source apparatus and the sink apparatus. Therefore, it is assumed that the reception power at the sink apparatus gradually reduces for the electromagnetic wave transmitted from the source apparatus.

In the embodiment of the third wireless communication apparatus 300, the average of the reception power I1 and the reception power I2 is represented by Im (=(I1+I2)/2). If the reception power is higher than Im, it is determined that there are no electromagnetic wave absorbing materials between the source apparatus and the sink apparatus, or if the reception power is lower than Im, it is determined that there is an electromagnetic wave absorbing material between the source apparatus and the sink apparatus. Im is just an example; it can be set appropriately.

Further, if it is determined that there are no electromagnetic wave absorbing materials between the source apparatus and the sink apparatus, this state may be assigned “0”, or if it is determined that there is an electromagnetic wave absorbing material between the source apparatus and the sink apparatus, this state may be assigned “1”, so that the states can be distinguished and indicated to the first wireless communication apparatus 100 and the second wireless communication apparatus 200, by transmitting the assigned values along with time information. Thus, an existence of an electromagnetic wave absorbing material can be confirmed.

Also, a complex operation may be recognized by providing multiple antennas on the third wireless communication apparatus 300 to process reception strengths of an electromagnetic wave at the antennas as time series data, or a user's behavior may be recognized by using various data, such as time required after the transmission until the reception of an electromagnetic wave, and a packet error rate, in addition to the reception strength of the electromagnetic wave.

FIG. 5 illustrates an example of correspondences between operational patterns for the source apparatus, and reception strengths of an electromagnetic wave, which has been transmitted from the source apparatus, when received at the sink apparatus. In the present embodiment of the communication system, by changing the reception strength of an electromagnetic wave at the sink apparatus transmitted from the source apparatus, the source apparatus is operated. The sink apparatus identifies that an operation is performed for a source apparatus, by having the operation for the source apparatus associated with the reception strength of an electromagnetic wave transmitted from the source apparatus. Namely, the third wireless communication apparatus 300 identifies operations for the first wireless communication apparatus 100 and the second wireless communication apparatus 200, by having the operations associated with the reception strengths of electromagnetic waves transmitted from the first wireless communication apparatus 100 and the second wireless communication apparatus 200, respectively. Thus, the third wireless communication apparatus 300 can determine whether an operation is performed for the first wireless communication apparatus 100 or the second wireless communication apparatus 200, based on the reception strength of an electromagnetic wave transmitted from the first wireless communication apparatus 100 or the second wireless communication apparatus 200.

An operational pattern A illustrates a temporal change of the reception strength of an electromagnetic wave transmitted from one of the first wireless communication apparatus 100 and the second wireless communication apparatus 200, which is detected at the third wireless communication apparatus 300, when a user operation A is performed for one of the first wireless communication apparatus 100 and the second wireless communication apparatus 200.

An operational pattern B illustrates a temporal change of the reception strength of an electromagnetic wave transmitted from one of the first wireless communication apparatus 100 and the second wireless communication apparatus 200, which is detected at the third wireless communication apparatus 300, when a user operation B is performed for one of the first wireless communication apparatus 100 and the second wireless communication apparatus 200.

Time when the reception power i becomes lower than Im is set as time to start a process to determine an operational pattern. In FIG. 5, for both the operational pattern A and the operational pattern B, the reception power i at the sink apparatus becomes lower than Im at time k+1 (t=k+1), time k+1 is determined as time to start a process to determine an operational pattern. After having started the process to determine an operational pattern, based on the time when the reception power exceeds Im at the sink apparatus, either of the pattern A or the pattern B is determined. Further, the pattern A and the pattern B may be associated with the identifiers of the first wireless communication apparatus 100 and the identifier of the second wireless communication apparatus 200.

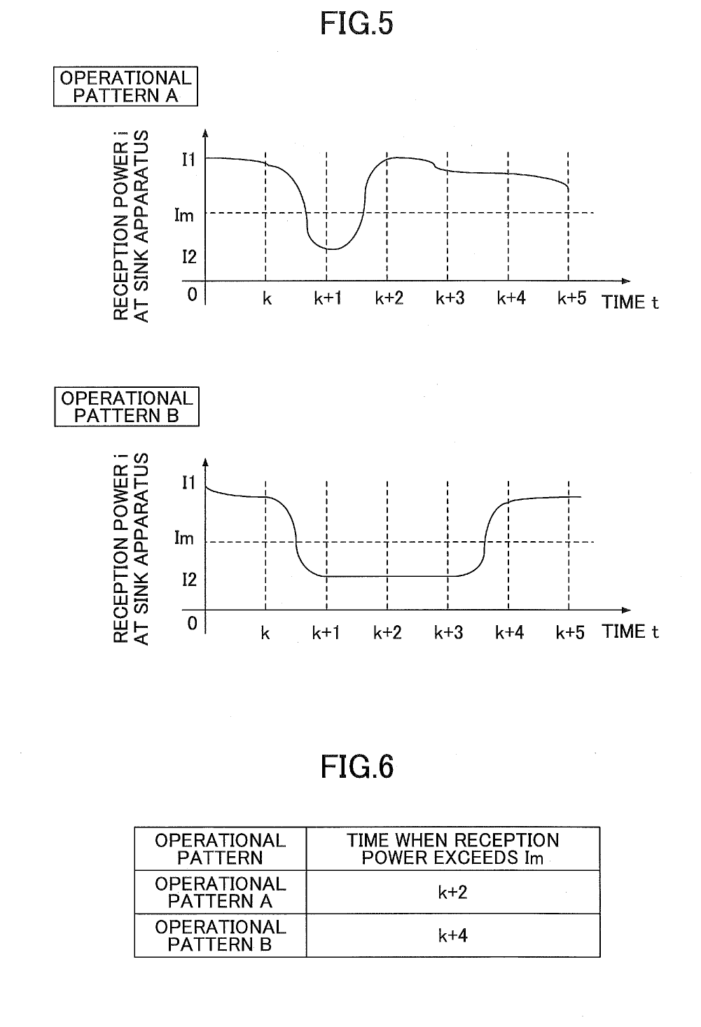

FIG. 6 illustrates an example of an operation determination table. The operation determination table includes the operational pattern A and the operational pattern B as switching patterns of a wireless communication destination, which are associated with respective times when the reception power exceeds Im after the process to determine an operational pattern has started. Namely, Im is set as a threshold, and one of the operational patterns is determined based on a predetermined period of time during which the reception power is less than or equal to the threshold. In FIG. 6, the user operation has started at time k+1 (t=k+1). If the reception power exceeds Im at time k+2, it is determined as the operational pattern A, or if the reception power exceeds Im at time k+4, it is determined as the operational pattern B.

The video/audio output processing unit 308 inputs video/audio data into the video/audio input terminal connected with which the third wireless communication apparatus 300 is connected. It is preferable that the video/audio input terminal is compliant with standards such as DVI or HDMI. The video/audio output processing unit 308 inputs video data and audio data from the control unit 310 into the video/audio input terminal.

The control unit 310 as a communication control unit is connected with the wireless communication process unit 302, the apparatus information storage unit 304, the wireless communication information storage unit 306, and the video/audio output processing unit 308. The control unit 310 controls the wireless communication process unit 302, the apparatus information storage unit 304, the wireless communication information storage unit 306, and the video/audio output processing unit 308. The control unit 310 is preferably constituted with a CPU and a memory.

The control unit 310 executes a synchronization process by synchronization signals from the first wireless communication apparatus 100 and the second wireless communication apparatus 200.

Based on the operation determination table stored in the wireless communication information storage unit 306, the control unit 310 determines whether a detection result of the reception power strength of an electromagnetic wave transmitted from one of the first wireless communication apparatus 100 and the second wireless communication apparatus 200, which is input from the wireless communication process unit 302, corresponds the operational pattern A or the operational pattern B. If determining that the detection result corresponds the operational pattern A, the control unit 310 executes control for transmitting a transmission start request to the first wireless communication apparatus 100, and transmitting a transmission stop request to the second wireless communication apparatus 200. Also, if determining that the detection result corresponds to the operational pattern B, the control unit 310 executes control for transmitting a transmission stop request to the first wireless communication apparatus 100, and transmitting a transmission start request to the second wireless communication apparatus 200.

Based on responses to the control data transmitted to the first wireless communication apparatus 100 and the second wireless communication apparatus 200, the control unit 310 executes communication control with the first wireless communication apparatus 100 and the second wireless communication apparatus 200. Specifically, when receiving as input the response to the transmission start request that has been transmitted to the first wireless communication apparatus 100, and receiving as input the response to the transmission stop request that has been transmitted to the second wireless communication apparatus 200, the control unit 310 executes control for inputting the video/audio data being transmitted from the first wireless communication apparatus 100, into the video/audio output processing unit 308. Alternatively, when receiving as input the response to the transmission stop request that has been transmitted to the first wireless communication apparatus 100, and receiving as input the response to the transmission start request that has been transmitted to the second wireless communication apparatus 200, the control unit 310 executes control for inputting the video/audio data transmitted from the second wireless communication apparatus 100, into the video/audio output processing unit 308.

The video/audio output processing unit 308 outputs the video/audio data from the control unit 310 to a video/audio input terminal of a display unit (not illustrated) with which the third wireless communication apparatus 300 is connected. It is preferable that the video/audio input terminal is compliant with standards such as DVI or HDMI.

The video/audio data is input into the video/audio input process unit 102 of the first wireless communication apparatus 100. The video/audio data is wirelessly transmitted via the wireless communication process unit 110 and the antenna. The video/audio data is received by the wireless communication process unit 302 of the third wireless communication apparatus 300. The video/audio data is output from the video/audio output processing unit 308 to a video/audio input terminal of a display unit such as a monitor or an external projector.

<First Reception/Transmission Process in Wireless Network Projector System>

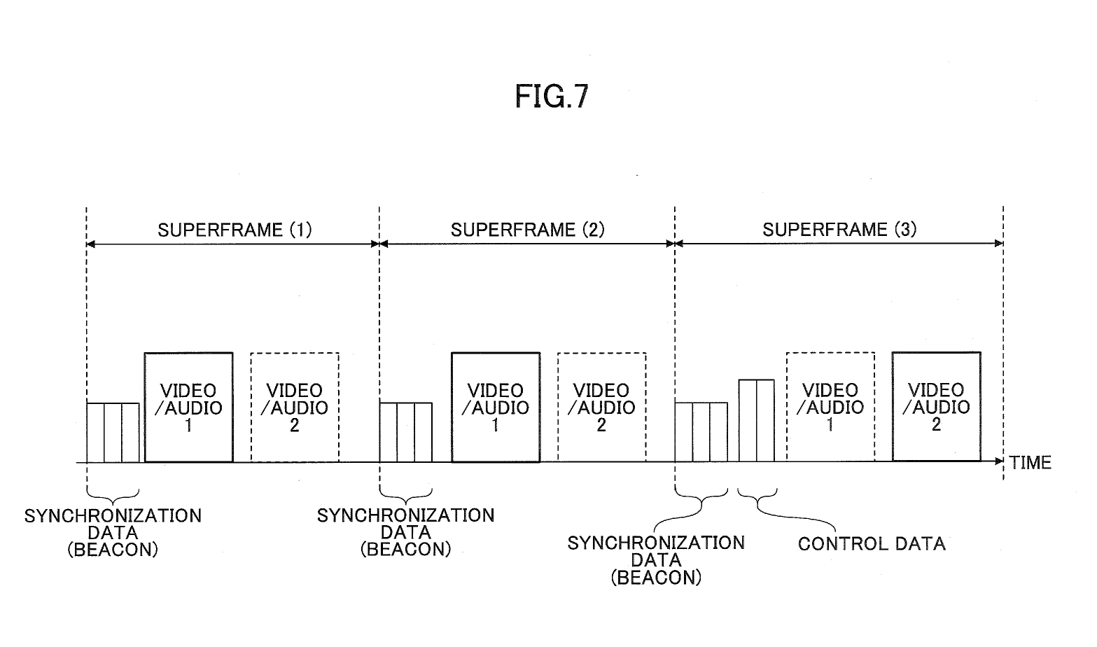

FIG. 7 illustrates a reception/transmission process in a wireless network projector system according to a first embodiment.

It is preferable that the first wireless communication apparatus 100, the second wireless communication apparatus 200, and the third wireless communication apparatus 300 execute communication by a Time Division Multiple Access (TDMA: Time Division Multiple Access) communication method in which the same frequency band is partitioned temporally and plurally. A TDMA communication method is used in WiMedia or millimeter-wave communication.

In FIG. 7, the horizontal axis represents time. In the present embodiment of a TDMA communication method, the first wireless communication apparatus 100 to the third wireless communication apparatus 300, which participate in the network, transmit synchronization data (beacon) for every predetermined time cycle. The predetermined time may be called a superframe. By having the first wireless communication apparatus 100 to the third wireless communication apparatus 300 transmit the synchronization data, a participation process in the network, and a band reservation negotiation process for data communication are executed.

During the predetermined time, other than the synchronization data, control data and data specific to applications are received and transmitted. The data specific to applications includes video data and audio data. When the first wireless communication apparatus 100 to the third wireless communication apparatus 300 execute a band reservation negotiation process for data communication, it is preferable to determine by a negotiation which time interval in a superframe is used by which wireless communication apparatus to transmit video data and audio data.

In the present embodiment of the reception/transmission process in the wireless network projector system, a time interval is determined during which a first source apparatus or a second source apparatus can alternately transmit video/audio data within a predetermined interval represented by a superframe, and one time for each of the source apparatuses.

In an example illustrated in FIG. 7, during first two consecutive superframes (1) and (2), the first source apparatus transmits video/audio data (video/audio 1) to the sink apparatus. In FIG. 7, data is transmitted during time intervals designated by solid lines, and data is not transmitted during time intervals designated by dashed lines. Also, in a superframe (3), the second source apparatus transmits video/audio data (video/audio 2) to the sink apparatus. Within a period after the first source apparatus has stopped the transmission of video/audio data, until the second source apparatus starts transmitting the video/audio data, the first wireless communication apparatus 100 to the third wireless communication apparatus 300 receive and transmit control data among each other.

<Second Reception/Transmission Process in Wireless Network Projector System>

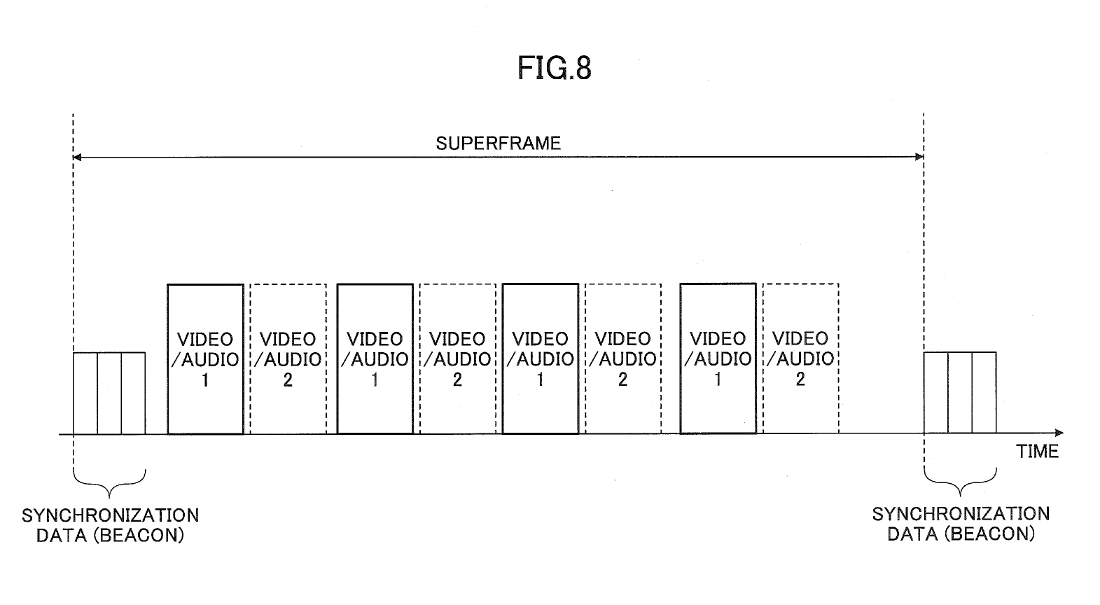

FIG. 8 is a diagram illustrating a reception/transmission process in a wireless network projector system according to a second embodiment.

It is preferable that the first wireless communication apparatus 100, the second wireless communication apparatus 200, and the third wireless communication apparatus 300 execute communication by a Time Division Multiple Access (TDMA: Time Division Multiple Access) communication method in which the same frequency band is partitioned temporally and plurally. A TDMA communication method is used in WiMedia or millimeter-wave communication.

In FIG. 8, the horizontal axis represents time. In the present embodiment of a TDMA communication method, the first wireless communication apparatus 100 to the third wireless communication apparatus 300, which participate in the network, transmit synchronization data (beacon) for every predetermined time cycle. The predetermined time may be called a superframe. By having the first wireless communication apparatus 100 to the third wireless communication apparatus 300 transmit the synchronization data, a participation process in the network, and a band reservation negotiation process for data communication are executed.

During the predetermined time, other than the synchronization data, control data and data specific to applications are received and transmitted. The data specific to applications includes video data and audio data. When the first wireless communication apparatus 100 to the third wireless communication apparatus 300 executes a band reservation negotiation process for data communication, it is preferable to determine by a negotiation which time interval in a superframe is used by which wireless communication apparatus to transmit video data and audio data.

In the present embodiment of the reception/transmission process in the wireless network projector system, a time interval is determined during which a first source apparatus or a second source apparatus can alternately transmit video/audio data within a predetermined interval represented by a superframe, and multiple times for each of the source apparatuses.

In an example illustrated in FIG. 8, during a superframe, the first source apparatus transmits video/audio data (video/audio 1) to the sink apparatus four times, separated by predetermined short time intervals. In FIG. 8, data is transmitted during time intervals designated by solid lines, and data is not transmitted during time intervals designated by dashed lines. By alternately setting time intervals for the first source apparatus to transmit data to the sink apparatus, and time intervals for the second source apparatus to transmit data to the sink apparatus, which are separated by short time intervals, when the sink apparatus inputs the video/audio data into the video/audio input terminal, arrival time differences can be shortened between the video/audio data from the first source apparatus and the video/audio data from the second source apparatus.

<Operations of Wireless Network Projector System>

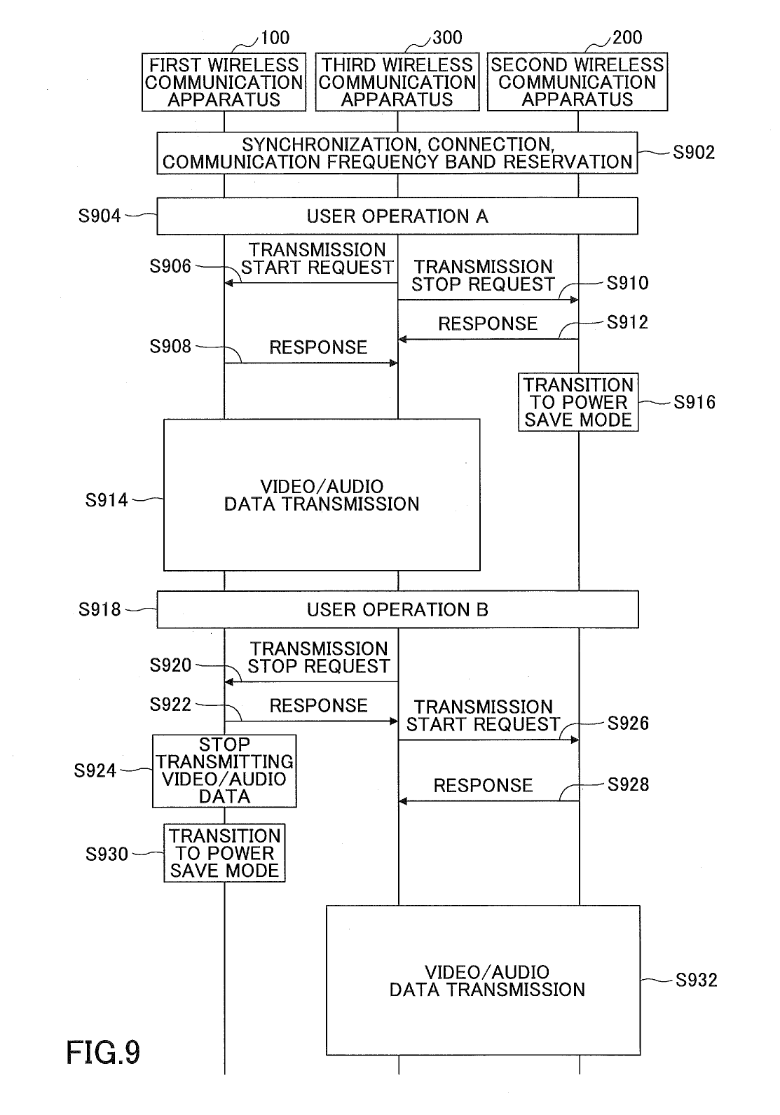

FIG. 9 illustrates operations of the wireless network projector system according to an embodiment.

In an example illustrated in FIG. 9, the third wireless communication apparatus 300 determines that a user operation A has been performed that corresponds to the operational pattern A, and then, determines that a user operation B has been performed that corresponds to the operational pattern B.

At Step S902, among the first wireless communication apparatus 100, the second wireless communication apparatus 200, and the third wireless communication apparatus 300, a synchronization process, a connection process, and a communication frequency band reservation process are executed for a wireless communication. The synchronization process, the connection process, and the communication frequency band reservation process are executed following standards set among the first wireless communication apparatus 100, the second wireless communication apparatus 200, and the third wireless communication apparatus 300. For example, the processes are executed following the standards such as WiMedia or IEEE802.15.3c.

At Step S904, the third wireless communication apparatus 300 determines that a user operation A has been performed based on electromagnetic waves from the first wireless communication apparatus 100 and the second wireless communication apparatus 200. For example, the control unit 310 of the third wireless communication apparatus 300 determines that a user operation corresponds to the operational pattern A from the reception power strengths of the electromagnetic waves transmitted from the first wireless communication apparatus 100 and the second wireless communication apparatus 200, which are input from the wireless communication process unit 302, based on the operation determination table stored in the wireless communication information storage unit 306.

At Step S906, the third wireless communication apparatus 300 makes a transmission start request to the first wireless communication apparatus 100.

At Step S908, the first wireless communication apparatus 100 makes a response to the transmission start request, back to the third wireless communication apparatus 300.

At Step S910, the third wireless communication apparatus 300 makes a transmission stop request to the second wireless communication apparatus 200.

At Step S912, the second wireless communication apparatus 200 makes a response to the transmission stop request, back to the third wireless communication apparatus 300.

At Step S906, by having the third wireless communication apparatus 300 make the transmission start request to the first wireless communication apparatus 100, control data is exchanged between the third wireless communication apparatus 300 and the second wireless communication apparatus 200, to stop transmission from the second wireless communication apparatus 200.

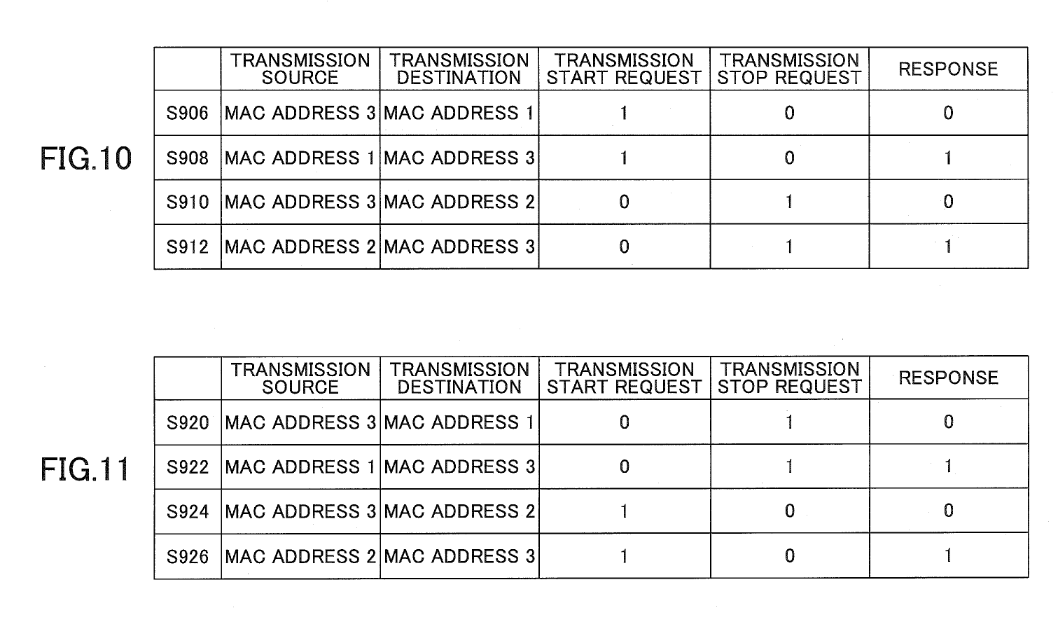

FIG. 10 illustrates messages transmitted at Steps S906, S908, S910, and S912 according to the present embodiment.

In FIG. 10, MAC addresses for the first wireless communication apparatus 100, the second wireless communication apparatus 200, and the third wireless communication apparatus 300 are referred to as MAC address 1, MAC address 2, and MAC address 3, respectively. Also, information representing a transmission start request, information representing a transmission stop request, and information representing a response are all represented by one-bit codes, respectively. By having the first wireless communication apparatus 100, the second wireless communication apparatus 200, and the third wireless communication apparatus 300 receive and transmit messages among each other that include the MAC address of a transmission source, the MAC address of a transmission destination, one of the information among the information representing a transmission start request, the information representing a transmission stop request, and the information representing a response, it is possible to recognize the meaning of a message on the reception side of the message. By having the first wireless communication apparatus 100, the second wireless communication apparatus 200, and the third wireless communication apparatus 300 receive and transmit messages among each other that include the MAC address of a transmission source, the MAC address of a transmission destination, one of the information among the information representing a transmission start request, the information representing a transmission stop request, and the information representing a response, it is possible to recognize the meaning of a message on the reception side of the message.

At Step S914, the first wireless communication apparatus 100 transmits video/audio data to the third wireless communication apparatus 300. The first wireless communication apparatus 100 transmits the video/audio data, following standards set among the first wireless communication apparatus 100, the second wireless communication apparatus 200, and the third wireless communication apparatus 300. For example, the processes are executed following the standards such as WiMedia or IEEE802.15.3c. Specifically, the video/audio data is incidental to a frame body of the basic format of a MAC frame, which has been described with reference to FIG. 2. In wireless communication standards such as WiMedia, IEEE802.15.3c, and the wireless LAN, a communication partner is identified by using an address such as a MAC address that can distinguish the communication partner from the others.

At Step S916, the second wireless communication apparatus 200 transitions to a power save mode. It is preferable to have the second wireless communication apparatus 200 transition to a power save mode because the second wireless communication apparatus 200 does not transmit video/audio data. For example, the second wireless communication apparatus 200 transitions to a power save mode, by enabling hardware clock gating. Namely, if the video/audio input process unit 202 is configured by hardware, the second wireless communication apparatus 200 stops supplying a clock or a power source to be input into the video/audio input process unit 202.

At Step S918, the third wireless communication apparatus 300 determines that a user operation B is performed based on electromagnetic waves from the first wireless communication apparatus 100 and the second wireless communication apparatus 200. For example, the control unit 310 of the third wireless communication apparatus 300 determines that a user operation corresponds to the operational pattern B from the reception power strengths of the electromagnetic waves transmitted from the first wireless communication apparatus 100 and the second wireless communication apparatus 200, which are input from the wireless communication process unit 302, based on the operation determination table stored in the wireless communication information storage unit 306.

At Step S920, the third wireless communication apparatus 300 makes a transmission stop request to the first wireless communication apparatus 100.

At Step S922, the first wireless communication apparatus 100 makes a response to the transmission stop request, back to the third wireless communication apparatus 300.

At Step S924, the first wireless communication apparatus 100 stops transmitting the video/audio data.

At Step S926, the third wireless communication apparatus 300 makes a transmission start request to the second wireless communication apparatus 200. By using the synchronization data (beacon), the third wireless communication apparatus 300 resumes an operational mode from the power save mode.

At Step S928, the second wireless communication apparatus 200 makes a response to the transmission start request, back to the third wireless communication apparatus 300.

FIG. 11 illustrates messages transmitted at Steps S920, 922, 5924, and S926 according to the present embodiment.

In FIG. 11, MAC addresses for the first wireless communication apparatus 100, the second wireless communication apparatus 200, and the third wireless communication apparatus 300 are referred to as MAC address 1, MAC address 2, and MAC address 3, respectively. Also, information representing a transmission start request, information representing a transmission stop request, and information representing a response are all represented by one-bit codes, respectively. By having the first wireless communication apparatus 100, the second wireless communication apparatus 200, and the third wireless communication apparatus 300 receive and transmit messages among each other that include the MAC address of a transmission source, the MAC address of a transmission destination, one of the information among the information representing a transmission start request, the information representing a transmission stop request, and the information representing a response, it is possible to recognize the meaning of a message on the reception side of the message.

At Step S930, the first wireless communication apparatus 100 transitions to a power save mode. It is preferable to have the first wireless communication apparatus 100 transition to a power save mode because the first wireless communication apparatus 100 does not transmit video/audio data. For example, the first wireless communication apparatus 100 transitions to a power save mode, by enabling hardware clock gating. Namely, if the video/audio input process unit 102 is configured by hardware, the first wireless communication apparatus 100 stops supplying a clock or a power source to be input into the video/audio input process unit 102.

At Step S932, the second wireless communication apparatus 200 transmits video/audio data to the third wireless communication apparatus 300. The second wireless communication apparatus 200 transmits the video/audio data, following standards set among the first wireless communication apparatus 100, the second wireless communication apparatus 200, and the third wireless communication apparatus 300. For example, the processes are executed following the standards such as WiMedia or IEEE802.15.3c. Specifically, the video/audio data is incidental to a frame body of the basic format of a MAC frame, which has been described with reference to FIG. 2. In wireless communication standards such as WiMedia, IEEE802.15.3c, and the wireless LAN, a communication partner is identified by using an address such as a MAC address that can distinguish the communication partner from the others.

The order of the steps is not limited to that illustrated in FIG. 9, which is just an example, and a different order may be adopted for the operation.

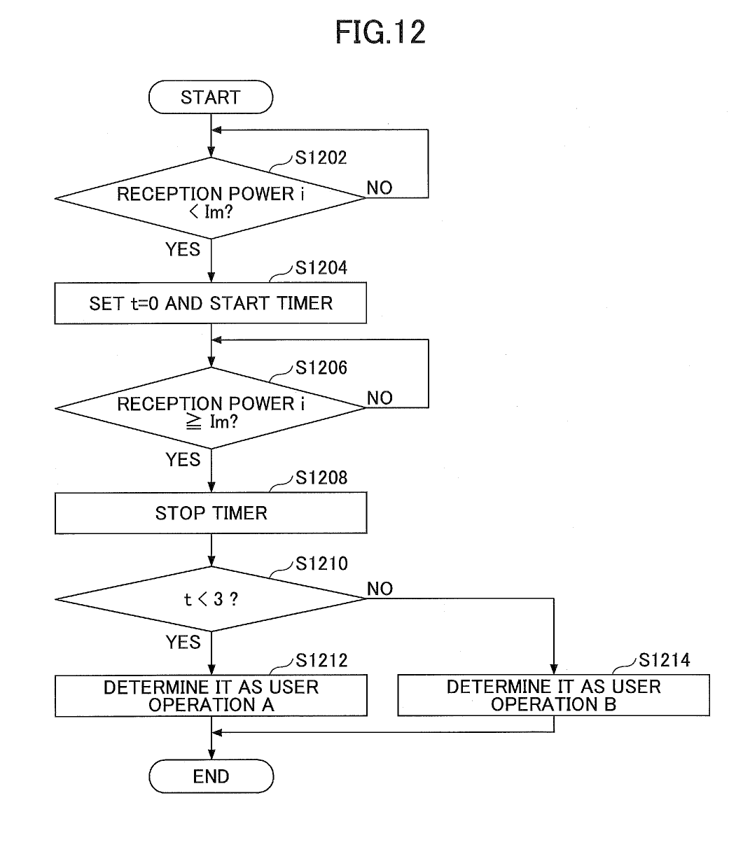

FIG. 12 illustrates a process in which the third wireless communication apparatus 300 determines operations that have been executed for the first wireless communication apparatus 100 and the second wireless communication apparatus 200. Namely, this corresponds to the process of Steps S904 and S918 in FIG. 9.

At Step S1202, the control unit 310 of the third wireless communication apparatus 300 determines whether the reception power i of the electromagnetic waves transmitted from the first wireless communication apparatus 100 and the second wireless communication apparatus 200 is greater than Im. If the reception power i of the electromagnetic waves transmitted from the first wireless communication apparatus 100 and the second wireless communication apparatus 200 is greater than Im, the process goes back to Step S1202.

At Step S1204, if the reception power i of the electromagnetic waves transmitted from the first wireless communication apparatus 100 and the second wireless communication apparatus 200 is less than Im, the control unit 310 of the third wireless communication apparatus 300 starts a timer with setting t=0.

At Step S1206, the control unit 310 of the third wireless communication apparatus 300 determines whether the reception power i of the electromagnetic waves transmitted from the first wireless communication apparatus 100 and the second wireless communication apparatus 200 becomes greater than Im. If the reception power i of the electromagnetic waves transmitted from the first wireless communication apparatus 100 and the second wireless communication apparatus 200 does not become greater than Im, the control unit 310 of the third wireless communication apparatus 300 goes back to Step S1206.

At Step S1208, if the reception power i of the electromagnetic waves transmitted from the first wireless communication apparatus 100 and the second wireless communication apparatus 200 becomes greater than Im, the control unit 310 of the third wireless communication apparatus 300 stops the timer.

At Step S1210, the control unit 310 of the third wireless communication apparatus 300 determines whether the value of the timer is less than three.

At Step S1212, if the value of the timer is less than three, the control unit 310 of the third wireless communication apparatus 300 determines that it is a user operation A.

At Step S1214, if the value of the timer is greater than or equal to three, the control unit 310 of the third wireless communication apparatus 300 determines that it is a user operation B.

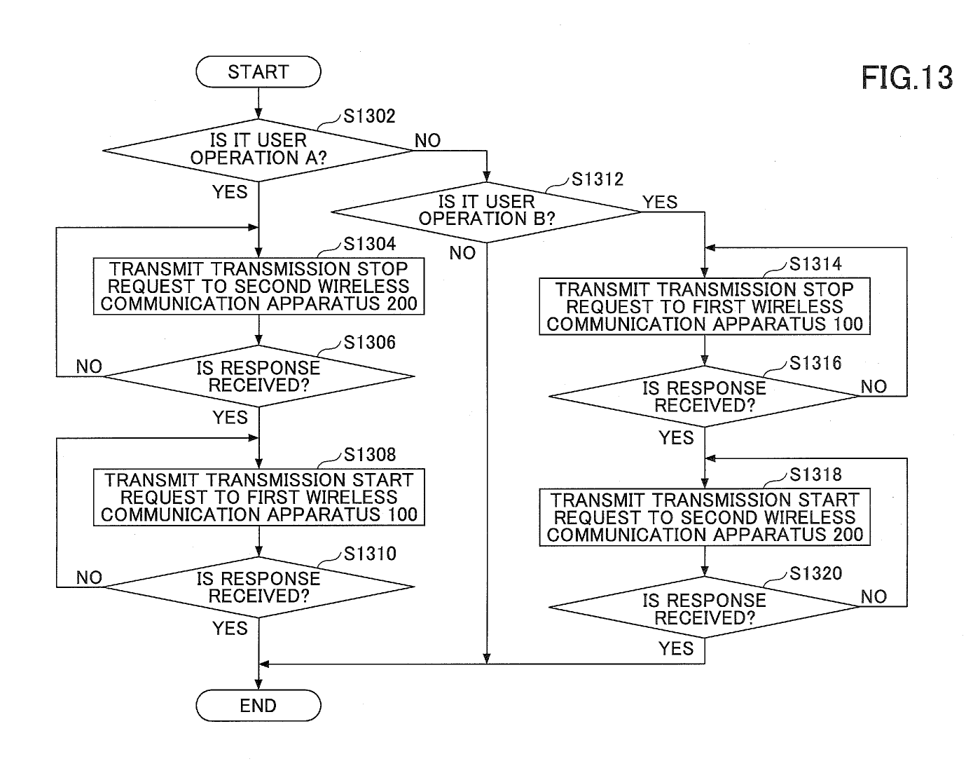

FIG. 13 illustrates a process which the third wireless communication apparatus 300 executes for the first wireless communication apparatus 100 and the second wireless communication apparatus 200, depending on the operations having been executed for the first wireless communication apparatus 100 and the second wireless communication apparatus 200. Namely, this corresponds to the processes of Steps S906-S912, Steps S920-S922, and Steps S926-S928 in FIG. 9.

At Step S1302, the control unit 310 of the third wireless communication apparatus 300 determines whether a user operation A has been performed.

At Step S1304, if determining that a user operation A has been performed, the control unit 310 of the third wireless communication apparatus 300 transmits a transmission stop request to the second wireless communication apparatus 200.

At Step S1306, the control unit 310 of the third wireless communication apparatus 300 determines whether a response to the transmission stop request has been received. If a response to the transmission stop request has not been received, the control unit 310 of the third wireless communication apparatus 300 goes back to Step S1304, and retransmits the transmission stop request.

At Step S1308, if a response to the transmission stop request has been received, the control unit 310 of the third wireless communication apparatus 300 transmits a transmission start request to the first wireless communication apparatus 100.

At Step S1310, the control unit 310 of the third wireless communication apparatus 300 determines whether a response to the transmission start request has been received. If a response to the transmission start request has not been received, the control unit 310 of the third wireless communication apparatus 300 goes back to Step S1308, and retransmits the transmission start request. On the other hand, if a response to the transmission start request has been received, the process ends.

At Step S1312, if determining that a user operation A has not been performed at Step S1302, the control unit 310 of the third wireless communication apparatus 300 determines whether a user operation B has been performed. If a user operation B has not been performed, the process ends.

At Step S1314, if determining that a user operation B has been performed, the control unit 310 of the third wireless communication apparatus 300 transmits a transmission stop request to the first wireless communication apparatus 100.

At Step S1316, the control unit 310 of the third wireless communication apparatus 300 determines whether a response to the transmission stop request has been received. If a response to the transmission stop request has not been received, the control unit 310 of the third wireless communication apparatus 300 goes back to Step S1314, and retransmits the transmission stop request.

At Step S1318, if a response to the transmission stop request has been received, the control unit 310 of the third wireless communication apparatus 300 transmits a transmission start request to the second wireless communication apparatus 200.

At Step S1320, the control unit 310 of the third wireless communication apparatus 300 determines whether a response to the transmission start request has been received. If a response to the transmission start request has not been received, the control unit 310 of the third wireless communication apparatus 300 goes back to Step S1318, and retransmits the transmission start request. On the other hand, if a response to the transmission start request has been received, the process ends.

According to the present embodiment of the wireless network projector system, a user can make the reception strength of an electromagnetic wave (wireless packet) damp, which is transmitted from a video/audio output unit, and to be received by an video/audio input unit, by holding an electromagnetic wave absorbing material such as a hand between one of multiple video/audio output units and a video/audio input unit. Based on the reception strength of an electromagnetic wave from the video/audio output unit to be received by this video/audio input unit, the wireless network projector system can recognize an operation performed for the video/audio output unit, and can determine an operation to be executed for the video/audio output unit. Namely, for a video/audio input unit including a projector, a monitor, and/or a loudspeaker, when a user wants to select one of multiple video/audio output units to have it execute wireless transmission and projection, the user can easily select a video/audio source to be projected, or switch among the sources. Therefore, when switching the video/audio output unit that outputs video/audio data, the user does not need to move to the position of a video/audio output unit that outputs the video/audio data. Namely, the user can have the single video/audio output unit switch data between the other video/audio output units to execute wireless transmission.

### Modified Example

A modified example of the communication system is substantially the same as that in FIG. 1.

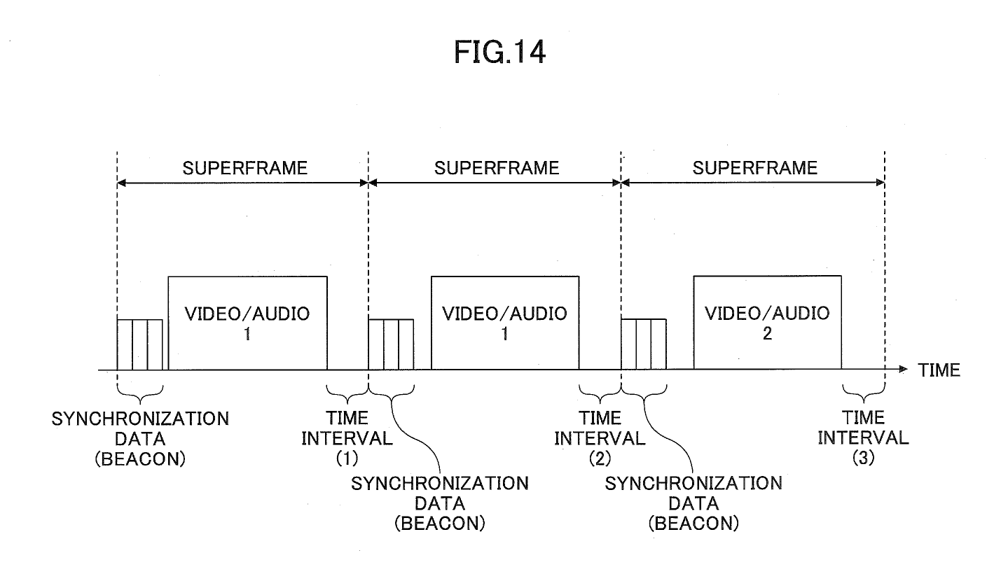

FIG. 14 illustrates a reception/transmission process in a wireless network projector system according to a third embodiment.

In FIG. 14, the horizontal axis represents time. In the embodiment of a TDMA communication method, the first wireless communication apparatus 100 to the third wireless communication apparatus 300, which participate in the network, transmit synchronization data (beacon) for every predetermined time cycle. The predetermined time may be called a superframe. By having the first wireless communication apparatus 100 to the third wireless communication apparatus 300 transmit the synchronization data, a participation process in the network, and a band reservation negotiation process for data communication are executed.

According to the first and second embodiments of the reception/transmission process in the wireless network projector system, time intervals are set in advance in a superframe during which the first and the second wireless communication apparatuses can transmit video/audio data.

According to the third modified example of the reception/transmission process in the wireless network projector system, after video/audio data has been transmitted in a superframe, by using a control frame and synchronization data, the communication band is released and reserved.

In an example illustrated in FIG. 14, during time intervals (1), (2), and (3), the communication band can be released and reserved.

For example, after the first wireless communication apparatus 100 has completed transmission of video/audio data to the third wireless communication apparatus 300, in the time interval (2), a control frame is received and transmitted between the first wireless communication apparatus 100 and the third wireless communication apparatus 300 to release the communication band. Also, a control frame is received and transmitted between the first wireless communication apparatus 100 and the second wireless communication apparatus 200 to reserve the communication band. Since a wireless communication can be executed between the third wireless communication apparatus 300, and one of the first wireless communication apparatus 100 and the second wireless communication apparatus 200 in a superframe, a large amount of video/audio data can be transmitted while controlling the time interval.

<Operations of Wireless Network Projector System>

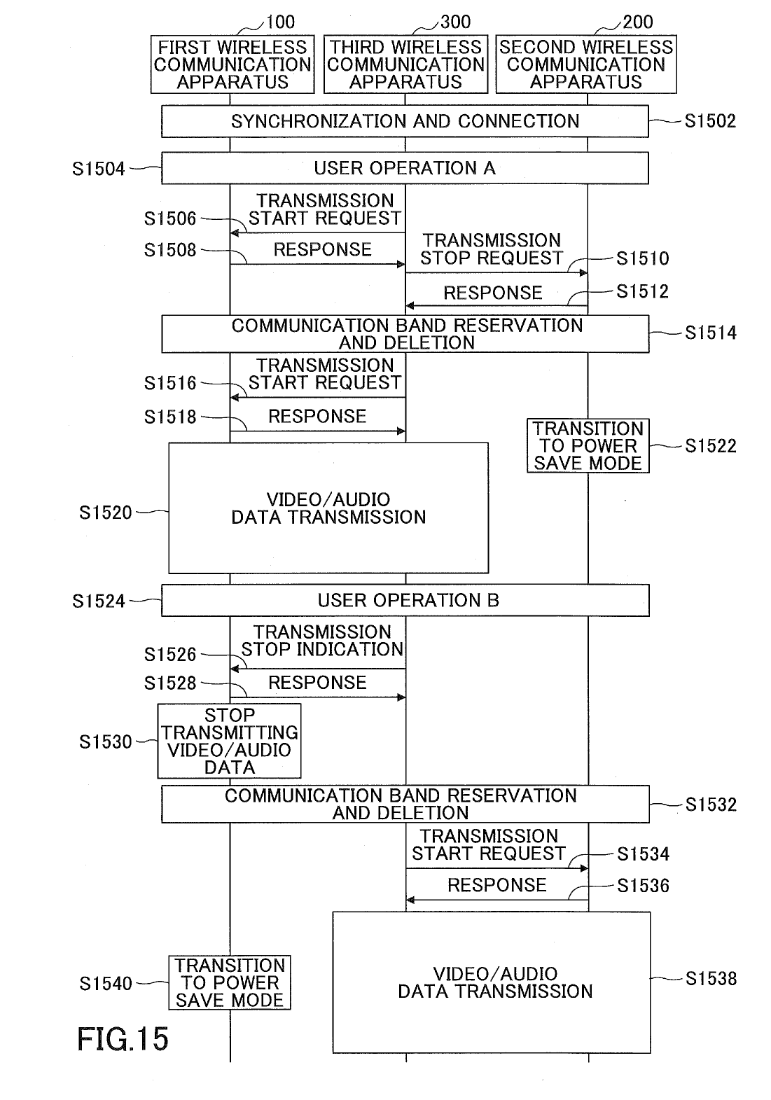

FIG. 15 illustrates operations of the wireless network projector system according to the modified example.

In an example illustrated in FIG. 15, the third wireless communication apparatus 300 determines that a user operation A has been performed that corresponds to the operational pattern A, and then, determines that a user operation B has been performed that corresponds to the operational pattern B.

At Step S1502, among the first wireless communication apparatus 100, the second wireless communication apparatus 200, and the third wireless communication apparatus 300, a synchronization process and a connection process are executed for a wireless communication. The synchronization process and the connection process are executed following standards set among the first wireless communication apparatus 100, the second wireless communication apparatus 200, and the third wireless communication apparatus 300. For example, the processes are executed following the standards such as WiMedia or IEEE802.15.3c.

At Step S1504, the third wireless communication apparatus 300 determines that a user operation A has been performed based on electromagnetic waves from the first wireless communication apparatus 100 and the second wireless communication apparatus 200. For example, the control unit 310 of the third wireless communication apparatus 300 determines that a user operation corresponds to the operational pattern A from the reception power strengths of the electromagnetic waves transmitted from the first wireless communication apparatus 100 and the second wireless communication apparatus 200, which are input from the wireless communication process unit 302, based on the operation determination table stored in the wireless communication information storage unit 306.

At Step S1506, the third wireless communication apparatus 300 makes a transmission start request to the first wireless communication apparatus 100.

At Step S1508, the first wireless communication apparatus 100 makes a response to the transmission start request, back to the third wireless communication apparatus 300.

At Step S1510, the third wireless communication apparatus 300 makes a transmission stop request to the second wireless communication apparatus 200.

At Step S1512, the second wireless communication apparatus 200 makes a response to the transmission stop request, back to the third wireless communication apparatus 300.

At Step S1514, among the first wireless communication apparatus 100, the second wireless communication apparatus 200, and the third wireless communication apparatus 300, a communication band reservation process and a communication reservation delete process are executed. For example, the communication band reservation process is executed between the first wireless communication apparatus 100 and the third wireless communication apparatus 300. Also, the communication reservation delete process is executed between the second wireless communication apparatus 200 and the third wireless communication apparatus 300.

At Step S1516, the third wireless communication apparatus 300 makes a transmission start request to the first wireless communication apparatus 100.

At Step S1518, the first wireless communication apparatus 100 transmits a response to the transmission start request, back to the third wireless communication apparatus 300.

At Step S1520, the first wireless communication apparatus 100 transmits video/audio data following standards set among the first wireless communication apparatus 100, the second wireless communication apparatus 200, and the third wireless communication apparatus 300. For example, the processes are executed following the standards such as WiMedia or IEEE802.15.3c. Specifically, the video/audio data is incidental to a frame body of the basic format of a MAC frame, which has been described with reference to FIG. 2. In wireless communication standards such as WiMedia, IEEE802.15.3c, and the wireless LAN, a communication partner is identified by using an address such as a MAC address that can distinguish the communication partner from the others.

At Step S1522, the second wireless communication apparatus 200 transitions to a power save mode. It is preferable to have the second wireless communication apparatus 200 transition to a power save mode because the second wireless communication apparatus 200 does not transmit video/audio data. For example, the second wireless communication apparatus 200 transitions to a power save mode, by enabling hardware clock gating. Namely, if the video/audio input process unit 202 is configured by hardware, the second wireless communication apparatus 200 stops supplying a clock or a power source to be input into the video/audio input process unit 202.

At Step S1524, the third wireless communication apparatus 300 determines that a user operation B is performed based on electromagnetic waves from the first wireless communication apparatus 100 and the second wireless communication apparatus 200. For example, the control unit 310 of the third wireless communication apparatus 300 determines that a user operation corresponds to the operational pattern B from the reception power strengths of the electromagnetic waves transmitted from the first wireless communication apparatus 100 and the second wireless communication apparatus 200, which are input from the wireless communication process unit 302, based on the operation determination table stored in the wireless communication information storage unit 306.

At Step S1526, the third wireless communication apparatus 300 makes a transmission stop request to the first wireless communication apparatus 100.

At Step S1528, the first wireless communication apparatus 100 makes a response to the transmission stop request, back to the third wireless communication apparatus 300.

At Step S1530, the first wireless communication apparatus 100 stops transmitting the video/audio data.

At Step S1532, among the first wireless communication apparatus 100, the second wireless communication apparatus 200, and the third wireless communication apparatus 300, a communication band reservation process and a communication reservation delete process are executed. For example, the communication reservation delete process is executed between the first wireless communication apparatus 100 and the third wireless communication apparatus 300. Also, the communication band reservation process is executed between the second wireless communication apparatus 200 and the third wireless communication apparatus 300.

At Step S1534, the third wireless communication apparatus 300 makes a transmission start request to the second wireless communication apparatus 200. By using the synchronization data (beacon), the third wireless communication apparatus 300 resumes an operational mode from the power save mode.

At Step S1536, the third wireless communication apparatus 300 transmits a response to the transmission start request, back to the first wireless communication apparatus 100.

At Step S1538, the second wireless communication apparatus 200 transmits video/audio data following standards set among the first wireless communication apparatus 100, the second wireless communication apparatus 200, and the third wireless communication apparatus 300. For example, the processes are executed following the standards such as WiMedia or IEEE802.15.3c. Specifically, the video/audio data is incidental to a frame body of the basic format of a MAC frame, which has been described with reference to FIG. 2. In wireless communication standards such as WiMedia, IEEE802.15.3c, and the wireless LAN, a communication partner is identified by using an address such as a MAC address that can distinguish the communication partner from the others.

At Step S1540, the first wireless communication apparatus 100 transitions to a power save mode. It is preferable to have the first wireless communication apparatus 100 transition to a power save mode because the first wireless communication apparatus 100 does not transmit video/audio data. For example, the first wireless communication apparatus 100 transitions to a power save mode, by enabling hardware clock gating. Namely, if the video/audio input process unit 102 is configured by hardware, the first wireless communication apparatus 100 stops supplying a clock or a power source to be input into the video/audio input process unit 102.

The order of the steps is not limited to that illustrated in FIG. 15, which is just an example, and a different order may be adopted for the operation.

By reserving a communication band and releasing the communication band every time when switching is executed for selecting an apparatus to transmit video/audio data between the first wireless communication apparatus 100 and the second wireless communication apparatus 200, a greater number of bands can be used, compared to a case where communication bands are fixed in advance, and timing to input and output video/audio data can be controlled.

### Second Embodiment

<Communication System>

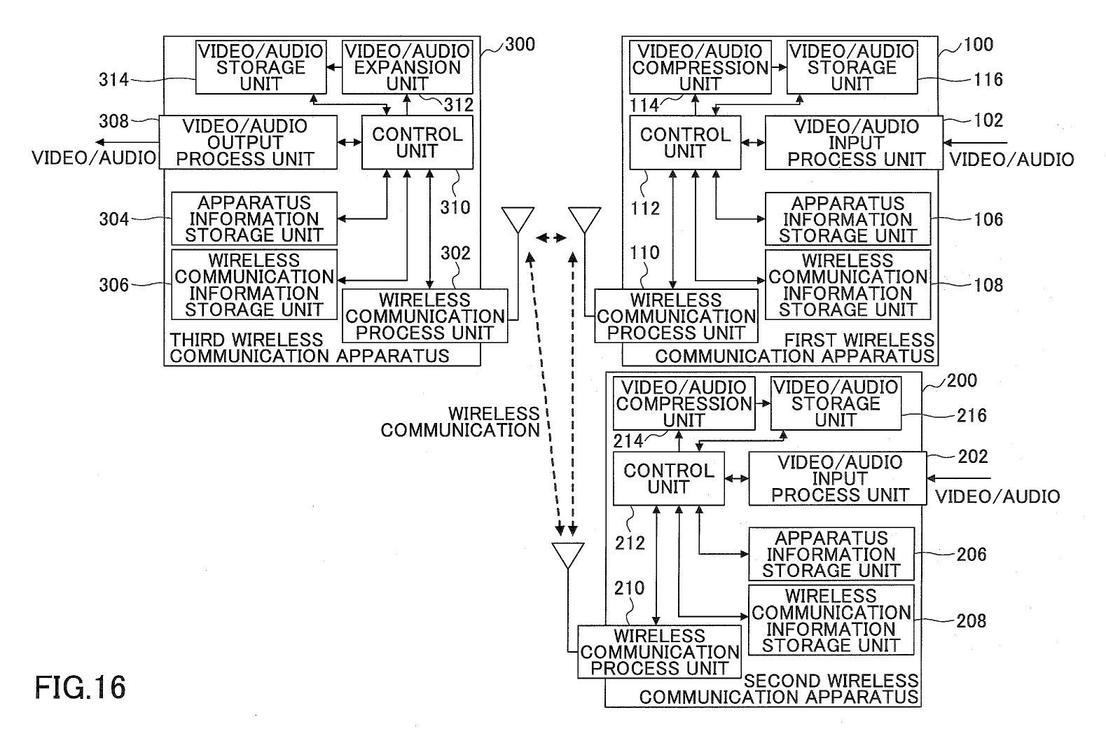

FIG. 16 illustrates an embodiment of a communication system. In FIG. 16, a wireless network projector system is illustrated as the embodiment of a communication system.

<First Wireless Communication Apparatus 100>

A first wireless communication apparatus 100 has a video/audio compression unit 114 and a video/audio storage unit 116 added to the first wireless communication apparatus 100 that has been described with reference to FIG. 1.

A video/audio compression unit 114 is connected with a control unit 112. When receiving video/audio data as input from the control unit 112, the video/audio compression unit 114 compresses the video/audio data. It is preferable that the video/audio compression unit 114 executes the compression process following H.264. Or, it is preferable that the video/audio compression unit 114 executes compression process following H.265. The video/audio compression unit 114 stores the compressed video/audio data in the video/audio storage unit 116.

If necessary, the control unit 112 inputs the video/audio data from the video/audio input process unit 102 into the video/audio compression unit 114. If it is set to compress the video/audio data, it is preferable that the control unit 112 inputs the video/audio data from the video/audio input process unit 102 into the video/audio compression unit 114. Also, the control unit 112 executes control for transmitting the compressed video/audio data stored in the video/audio storage unit 116 from the wireless communication process unit 110.

The control unit 112 determines whether control data input from the wireless communication process unit 110 is a transmission start request of video/audio data input from the video/audio input process unit 102, or a transmission stop request of video/audio data. The control unit 112 executes control for transmitting a response to a transmission start request input from the wireless communication process unit 110 back to the third wireless communication apparatus 300. If the control data is a transmission start request, the second wireless communication apparatus 200 and the third wireless communication apparatus 300 exchange the control data, and the second wireless communication apparatus 200 stops transmitting the video/audio data. Specifically, the third wireless communication apparatus 300 transmits to the second wireless communication apparatus 200, a transmission stop request to stop transmitting the video/audio data. In response to the transmission stop request from the third wireless communication apparatus 300, the control unit 212 of the second wireless communication apparatus 200 controls stopping the transmission of video/audio data.

The control unit 112 controls the wireless communication process unit 110 to transmit the video/audio data from the video/audio input process unit 102, to the third wireless communication apparatus 300.

The control unit 112 controls transmitting the response to the transmission stop request input from the wireless communication process unit 110, to the third wireless communication apparatus 300, and stops controlling the wireless communication process unit 110 to transmit the video/audio data from the video/audio input process unit 102, to the third wireless communication apparatus 300. If the control data is a transmission stop request, the second wireless communication apparatus 200 and the third wireless communication apparatus 300 exchange the control data, and the second wireless communication apparatus 200 transmits the video/audio data. Specifically, the third wireless communication apparatus 300 transmits to the second wireless communication apparatus 200, a transmission start request to start transmitting the video/audio data. In response to the transmission start request from the third wireless communication apparatus 300, the control unit 212 of the second wireless communication apparatus 200 controls starting the transmission of video/audio data.

The control unit 112 includes functions that are described as the functions of the control unit 212.

The video/audio storage unit 116 is connected with the video/audio compression unit 114 and the control unit 112. The video/audio storage unit 116 is a buffer used when compressing video/audio data. The video/audio storage unit 116 stores the compressed video/audio data from the video/audio compression unit 114.

The second wireless communication apparatus 200 is substantially the same as the first wireless communication apparatus 100, and its description is omitted.

<Third Wireless Communication Apparatus 300>

A third wireless communication apparatus 300 has a video/audio expansion unit 312 and a video/audio storage unit 314 added to the third wireless communication apparatus 300 that has been described with reference to FIG. 1.

The video/audio expansion unit 312 is connected with the control unit 310. When receiving compressed video/audio data as input from the control unit 310, the video/audio expansion unit 312 expands the video/audio data. It is preferable that the video/audio expansion unit 312 executes an expansion process following H.264. Or, it is preferable that the video/audio expansion unit 312 executes an expansion process following H.265. The video/audio expansion unit 312 stores the expanded video/audio data in the video/audio storage unit 314.

If necessary, the control unit 310 inputs the compressed video/audio data from the wireless communication process unit 302 into the video/audio expansion unit 312. Also, the control unit 310 executes control for outputting the expanded video/audio data stored in the video/audio storage unit 314 from the video/audio output processing unit 308.

Based on the operation determination table stored in the wireless communication information storage unit 306, the control unit 310 determines whether a detection result of the reception power strength of an electromagnetic wave transmitted from the wireless communication process unit 302 and the second wireless communication apparatus 200 input from the first wireless communication apparatus 100, corresponds the operational pattern A or the operational pattern B. If determining that the detection result corresponds the operational pattern A, the control unit 310 executes control for transmitting a transmission start request to the first wireless communication apparatus 100, and transmitting a transmission stop request to the second wireless communication apparatus 200. Also, if determining that the detection result corresponds to the operational pattern B, the control unit 310 executes control for transmitting a transmission stop request to the first wireless communication apparatus 100, and transmitting a transmission start request to the second wireless communication apparatus 200.

Based on responses to the control data transmitted to the first wireless communication apparatus 100 and the second wireless communication apparatus 200, the control unit 310 executes communication control between the first wireless communication apparatus 100 and the second wireless communication apparatus 200. Specifically, when receiving as input the response to the transmission start request transmitted to the first wireless communication apparatus 100, and receiving as input the response to the transmission stop request transmitted to the second wireless communication apparatus 200, the control unit 310 executes control for inputting the video/audio data transmitted from the first wireless communication apparatus 100, into the video/audio output processing unit 308. When receiving as input the response to the transmission stop request transmitted to the first wireless communication apparatus 100, and receiving as input the response to the transmission start request transmitted to the second wireless communication apparatus 200, the control unit 310 executes control for inputting the video/audio data transmitted from the second wireless communication apparatus 100, into the video/audio output processing unit 308.

The video/audio storage unit 314 is connected with the video/audio expansion unit 312 and the control unit 310. The video/audio storage unit 314 is a buffer used when expanding video/audio data. The video/audio storage unit 314 stores the expanded video/audio data from the video/audio expansion unit 312.

According to the present embodiment of the wireless network projector system, by having the first wireless communication apparatus 100 and the second wireless communication apparatus 200 compress video/audio data, the amount of the video/audio data can be reduced, and hence, a process load for a wireless communication process can be reduced. Also, by compressing the video/audio data, the amount of the video/audio data can be reduced, and hence, a time delay can be shortened in a wireless communication when the communication band is narrow.

Also, the control unit 310 inputs video/audio data from the first wireless communication apparatus 100 and the second wireless communication apparatus 200 into the video/audio expansion unit 312. The video/audio expansion unit 312 expands the video/audio data from the first wireless communication apparatus 100 and the second wireless communication apparatus 200, and stores the expanded data in the video/audio storage unit 314. When expanding the video/audio data from the first wireless communication apparatus 100 and the second wireless communication apparatus 200, and storing the expanded data in the video/audio storage unit 314, the video/audio expansion unit 312 may thin out the data. The control unit 310 synthesizes the expanded video/audio data from the first wireless communication apparatus 100 and the second wireless communication apparatus 200 stored in the video/audio storage unit 314, and transfers the data to the video/audio output processing unit 308 at virtually the same time.

By synthesizing the video/audio data from the first wireless communication apparatus 100 and the second wireless communication apparatus 200, and transferring the data to the video/audio output processing unit 308 at virtually the same time, it is possible to have a display unit such as a monitor display the video data from the first wireless communication apparatus 100 and the video data from the second wireless communication apparatus 200 at virtually the same time.

Also, if the video data is constituted with camera images that are captured by the first wireless communication apparatus 100 and the second wireless communication apparatus 200 having a little spatial difference with each other, the control unit 310 may synthesize the data to display 3D images.

### Third Embodiment

<Communication System>

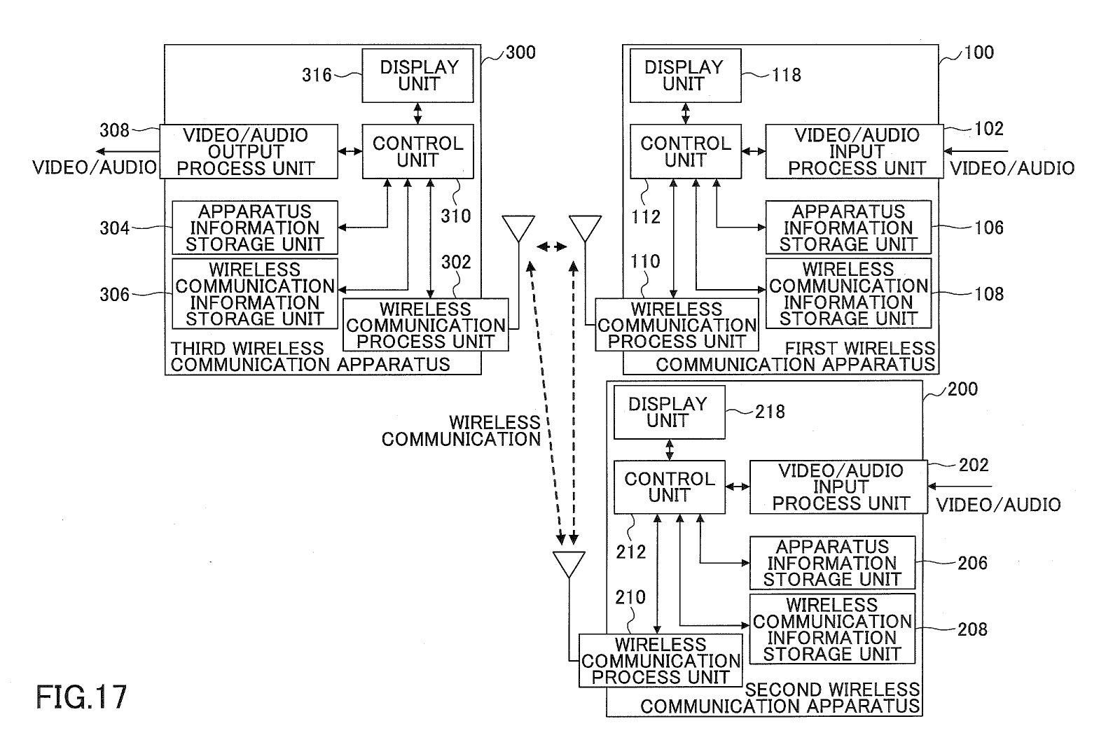

FIG. 17 illustrates an embodiment of a communication system. In FIG. 17, a wireless network projector system is illustrated as the embodiment of a communication system.

<First Wireless Communication Apparatus 100>

A first wireless communication apparatus 100 has a display unit 118 added to the first wireless communication apparatus 100 that has been described with reference to FIG. 1.

The display unit 118 is connected with the control unit 112. The display unit 118 displays whether video/audio data is being transmitted. Specifically, the display unit 118 displays that “the video/audio data is being transmitted” when video/audio data is being transmitted, or does not display that “the video/audio data is being transmitted” when video/audio data is not being transmitted.

It is preferable that the display unit 118 is constituted with LEDs (Light Emitting Diodes), an LCD (Liquid Crystal Display), or a LCD panel. Also, the display unit 118 may be constituted with a touch panel.

As a second wireless communication apparatus 200, the first wireless communication apparatus 100 can be used.

<Third Wireless Communication Apparatus 300>

A third wireless communication apparatus 300 has a display unit 316 added to the third wireless communication apparatus 300 that has been described with reference to FIG. 1.

The display unit 316 is connected with the control unit 310. The display unit 316 displays content of processing in the third wireless communication apparatus 300. Specifically, the display unit 316 displays that a video/audio data is being output when the video/audio output processing unit 308 is outputting video/audio data. Further, if the first wireless communication apparatus 100 and/or the second wireless communication apparatus 200 are outputting video/audio data, the display unit 316 displays information about those wireless communication apparatus.

It is preferable that the display unit 316 is constituted with LEDs, an LCD, or a LCD panel.

According to the present embodiment of the wireless network projector system, the first wireless communication apparatus 100 and the second wireless communication apparatus 200 can display whether video/audio data is being transmitted, and hence, a user can confirm operational states of the first wireless communication apparatus 100 and the second wireless communication apparatus 200, respectively.

<Operations of Wireless Network Projector system>

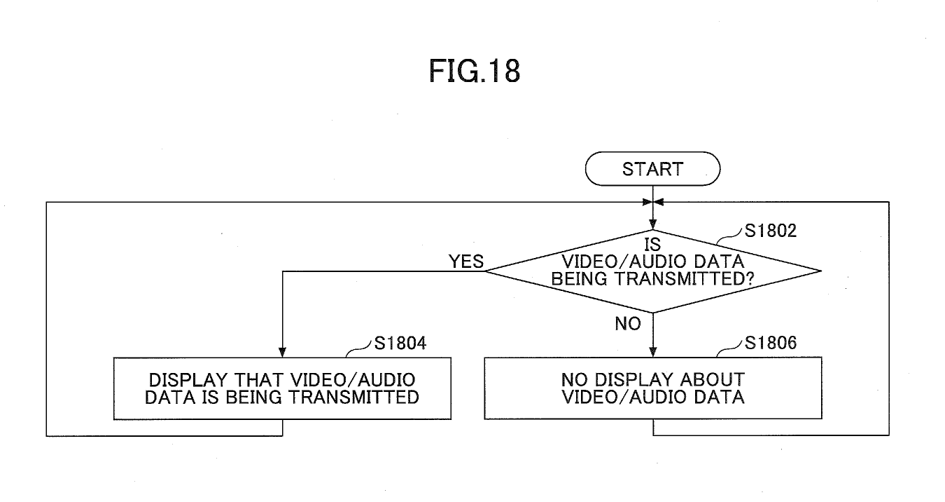

FIG. 18 illustrates operations of the wireless network projector system according to a modified example.

In an example illustrated in FIG. 18, a process is illustrated for displaying whether video/audio data is being transmitted from the first wireless communication apparatus 100. The process in FIG. 18 can be used for operations in the second wireless communication apparatus 200.

At Step S1802, the control unit 112 of the first wireless communication apparatus 100 determines whether video/audio data is being transmitted.

At Step S1804, if having determined at Step S1802 that video/audio data is being transmitted, the display unit 118 of the first wireless communication apparatus 100 displays that the video/audio data is being transmitted.

At Step S1806, if having determined at Step S1802 that video/audio data is not being transmitted, the display unit 118 of the first wireless communication apparatus 100 does not display that the video/audio data is being transmitted.

The display unit 118 may display communication quality such as a transmission rate when video/audio data is being transmitted to the third wireless communication apparatus 300. Also, the display unit 118 may display quality of video data when video/audio data is being transmitted to the third wireless communication apparatus 300. As quality of video data, parameters relating to the video data such as a resolution may be displayed.

### Fourth Embodiment

<Communication System>

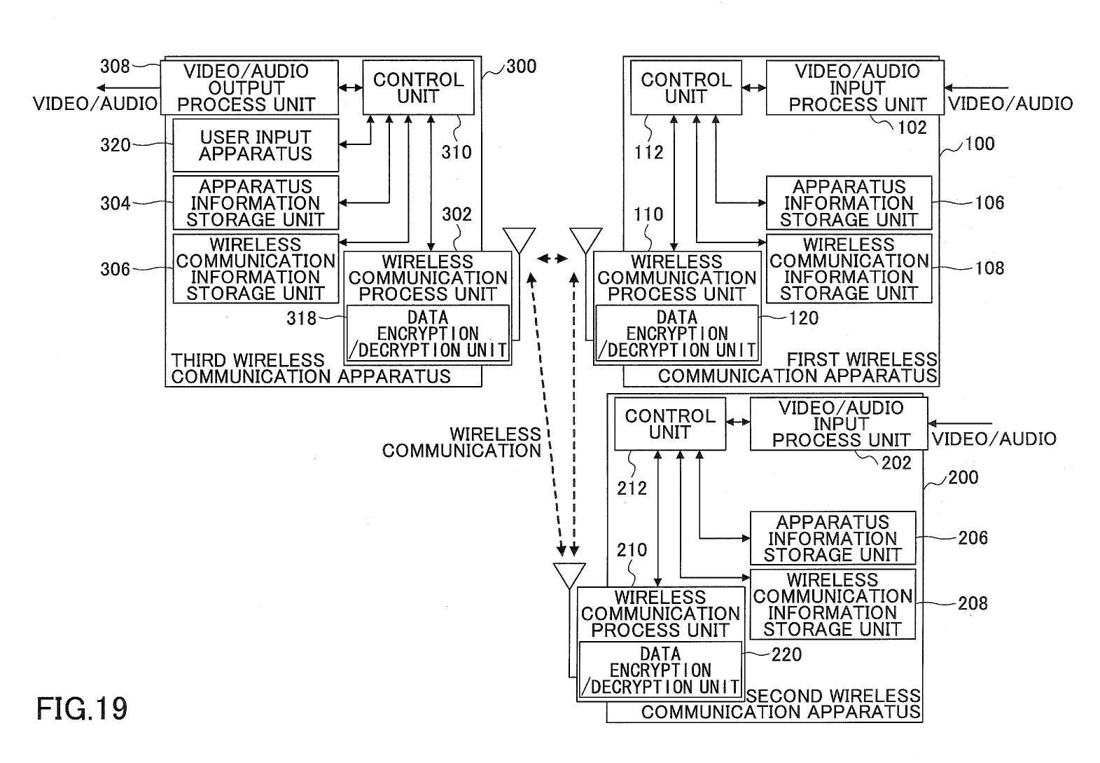

FIG. 19 illustrates an embodiment of a communication system. In FIG. 19, a wireless network projector system is illustrated as the embodiment of a communication system.

<First Wireless Communication Apparatus 100>

A first wireless communication apparatus 100 has a data encryption/decryption unit 120 added to the first wireless communication apparatus 100 that has been described with reference to FIG. 1.

The data encryption/decryption unit 120 generates a master key by using the same algorithm as in the third wireless communication apparatus 300. The data encryption/decryption unit 120 generates an encryption key from the master key and the MAC address of the third wireless communication apparatus 300. When generating the master key and generating the encryption key, the data encryption/decryption unit 120 may use a push-button method that is compliant with WPS (Wi-Fi Protected Setup) standards of the wireless LAN. Specifically, an encryption process is prepared by pushing buttons on the source apparatus and the sink apparatus, respectively. The data encryption/decryption unit 120 encrypts video/audio data by the encryption key, which is to be transmitted to the third wireless communication apparatus 300. The data having encrypted by the data encryption/decryption unit 120 is transmitted from the wireless communication process unit 110 to the third wireless communication apparatus 300.

<Third Wireless Communication Apparatus 300>

A third wireless communication apparatus 300 has a data encryption/decryption unit 318 added to the third wireless communication apparatus 300 that has been described with reference to FIG. 1.

The data encryption/decryption unit 318 generates a master key by using the same algorithm as in the first wireless communication apparatus 100. The data encryption/decryption unit 318 obtains a decryption key corresponding to an encryption key based on the master key and the MAC address of the third wireless communication apparatus 300. For example, the data encryption/decryption unit 318 may obtain the decryption key from a key issuance center (not illustrated). The data encryption/decryption unit 318 decrypts the encrypted data from the first wireless communication apparatus 100 by the decryption key, to input the data into the control unit 310.

<Operations of Wireless Network Projector system>

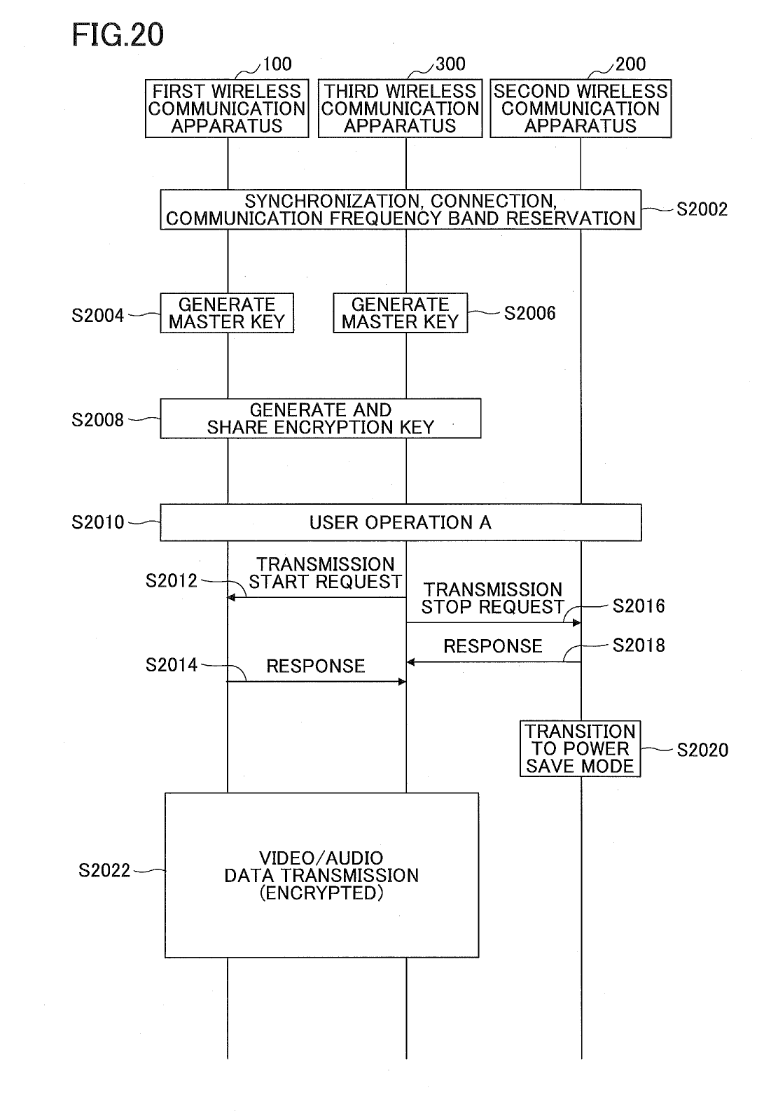

FIG. 20 illustrates operations of the wireless network projector system according to a modified example.

In an example illustrated in FIG. 20, a user operation A is performed for the first wireless communication apparatus 100 and the second wireless communication apparatus 200, and a command is executed by the third wireless communication apparatus 300 to have the first wireless communication apparatus 100 transmit video/audio data. The first wireless communication apparatus 100 transmits encrypted video/audio data, and the third wireless communication apparatus 300 decrypts the encrypted video/audio data from the first wireless communication apparatus 100.

At Step S2002, among the first wireless communication apparatus 100, the second wireless communication apparatus 200, and the third wireless communication apparatus 300, a synchronization process, a connection process, and a communication band reservation process are executed for a wireless communication. The synchronization process, the connection process, and the communication band reservation process are executed following standards set among the first wireless communication apparatus 100, the second wireless communication apparatus 200, and the third wireless communication apparatus 300. For example, the processes are executed following the standards such as WiMedia or IEEE802.15.3c.

At Step S2004, the first wireless communication apparatus 100 generates a master key.

At Step S2006, the third wireless communication apparatus 300 generates a master key.

At Step S2008, an encryption key is generated and shared between the first wireless communication apparatus 100 and the third wireless communication apparatus 300. For example, the first wireless communication apparatus 100 generates an encryption key based on the master key and the MAC address of the third wireless communication apparatus 300. The third wireless communication apparatus 300 obtains a decryption key based on the master key and the MAC address of the third wireless communication apparatus 300.

At Step S2010, the third wireless communication apparatus 300 determines that a user operation A has been performed based on electromagnetic waves from the first wireless communication apparatus 100 and the second wireless communication apparatus 200. For example, the control unit 310 of the third wireless communication apparatus 300 determines that a user operation corresponds to the operational pattern A from the reception power strengths of the electromagnetic waves transmitted from the first wireless communication apparatus 100 and the second wireless communication apparatus 200, which are input from the wireless communication process unit 302, based on the operation determination table stored in the wireless communication information storage unit 306.

At Step S2012, the third wireless communication apparatus 300 makes a transmission start request to the first wireless communication apparatus 100.

At Step S2014, the first wireless communication apparatus 100 makes a response to the transmission start request, back to the third wireless communication apparatus 300.

At Step S2016, the third wireless communication apparatus 300 makes a transmission stop request to the second wireless communication apparatus 200.

At Step S2018, the second wireless communication apparatus 200 makes a response to the transmission stop request, back to the third wireless communication apparatus 300.

At Step S2020, the second wireless communication apparatus 200 transitions to a power save mode. It is preferable to have the second wireless communication apparatus 200 transition to a power save mode because the second wireless communication apparatus 200 does not transmit video/audio data. For example, the second wireless communication apparatus 200 transitions to a power save mode, by enabling hardware clock gating. Namely, if the video/audio input process unit 202 is configured by hardware, the second wireless communication apparatus 200 stops supplying a clock or a power source to be input into the video/audio input process unit 202.

At Step S2022, the first wireless communication apparatus 100 transmits video/audio data following standards set among the first wireless communication apparatus 100, the second wireless communication apparatus 200, and the third wireless communication apparatus 300. For example, the processes are executed following the standards such as WiMedia or IEEE802.15.3c. Specifically, the video/audio data is incidental to a frame body of the basic format of a MAC frame, which has been described with reference to FIG. 2. In wireless communication standards such as WiMedia, IEEE802.15.3c, and the wireless LAN, a communication partner is identified by using an address such as a MAC address that can distinguish the communication partner from the others.

According to the present embodiment of the communication system, by transmitting encrypted video/audio data, likelihood can be reduced for the video/audio data to be stolen during a wireless transmission. Therefore, a system having a high security can be configured.

The present invention has been described with reference to the embodiments, which are just examples, and one skilled in the art will understand that variations, modifications, alternatives, and replacements can be made. Although the apparatuses according to the embodiments of the present invention are described using functional block diagrams for the sake of explanation, the apparatuses may be implemented by hardware, software, or a combination of hardware and software. The present invention is not limited to the embodiments described above, but variations, modifications, alternatives, and replacements may be made without departing from the scope of the present invention.

The present application is based on Japanese Priority Application No. 2014-052059, filed on Mar. 14, 2014, the entire contents of which are hereby incorporated by reference.

What is claimed is:

1. A wireless receiver apparatus, executing a wireless communication with a plurality of wireless transmitting apparatuses, comprising:
a radio wave strength detection unit configured to detect a reception radio wave strength from a first wireless transmitting apparatus executing the wireless communication;
a data source switching pattern storage unit configured to store a switching pattern to switch a data source of the wireless communication to a second wireless transmitting apparatus based on the reception radio wave strength from the first wireless transmitting apparatus;
a communication control unit configured to switch the data source of the wireless communication to the second wireless transmitting apparatus, based on the switching pattern stored in the data source switching pattern storage unit, and a detection result from the radio wave strength detection unit; and
a wireless communication unit configured to execute the wireless communication with the first wireless communication apparatus or the second wireless transmitting apparatus, depending on control by the communication control unit.

2. The wireless receiver apparatus, as claimed in claim 1, wherein the switching pattern stored in the data source switching pattern storage unit is information specifying that switching the data source of the wireless communication to the second wireless transmitting apparatus is to be executed when the reception radio wave strength from the first wireless transmitting apparatus has been less than or equal to a threshold for a predetermined length of time.

3. The wireless receiver apparatus, as claimed in claim 1, wherein the data source switching pattern storage unit stores the switching pattern having associated with identification information about the first wireless transmitting apparatus and the second wireless transmitting apparatus,
wherein the communication control unit switches the data source of the wireless communication to the second wireless transmitting apparatus, based on the switching pattern having associated with the identification information of the first wireless transmitting apparatus and the second wireless transmitting apparatus, stored in the data source switching pattern storage unit, and the detection result from and the radio wave strength detection unit.

4. The wireless receiver apparatus, as claimed in claim 1, further comprising:
a display unit configured to display an existence of the first wireless communication apparatus executing the wireless communication by the wireless communication unit.

5. The wireless receiver apparatus, as claimed in claim 1, wherein data transmitted from the data source of the wireless communication is video and audio data, further comprising:
a video and audio compression unit configured to compress the video and audio data; and
a video and audio expansion unit configured to expand the compressed video and audio data.

6. A wireless communication method, executed by a wireless receiver apparatus executing a wireless communication with a plurality of wireless transmitting apparatuses, the method comprising:
detecting a reception radio wave strength from a first wireless transmitting apparatus executing the wireless communication;
storing a switching pattern to switch a data source of the wireless communication to a second wireless transmitting apparatus based on the reception radio wave strength from the first wireless transmitting apparatus, the switching pattern being stored in a data source switching pattern storage unit;
switching the data source of the wireless communication to the second wireless transmitting apparatus, based on the switching pattern stored in the data source switching pattern storage unit and a detection result from the radio wave strength detection unit; and
a wireless communication unit configured to execute the wireless communication with the first wireless communication apparatus or the second wireless transmitting apparatus, depending on control by the communication control unit.
